(19) United States
(12) Patent Application Publication
(10) Pub. No.: US 2023/0119059 A1
(43) Pub. Date: Apr. 20, 2023

(54) BOTTLENECK STRUCTURES TO COMPUTE INCREMENTAL DIRECTIONS IN MULTIPATH MAX-MIN BANDWIDTH ALLOCATION

(71) Applicant: Reservoir Labs, Inc., San Diego, CA (US)

(72) Inventor: Jordi ROS GIRALT, Vilafranca del Penedes (ES)

(21) Appl. No.: 17/968,762

(22) Filed: Oct. 18, 2022

Related U.S. Application Data
(60) Provisional application No. 63/262,644, filed on Oct. 18, 2021.

(51) Int. Cl. H04L 47/127; H04L 41/14; H04L 41/147; H04L 47/76

(52) U.S. Cl. CPC H04L 47/127; H04L 41/145; H04L 41/147; H04L 47/76

(57) ABSTRACT

A processor-implemented method includes computing a bandwidth allocation for a number of flows in a number of flow groups. Pairs of nodes in a network transmit data to each other via at least one of the flows in one of the flow groups. Each of the flows traverses a path comprising a number of network links. The method also includes building a bottleneck structure graph for the flow groups. The method further includes calculating a network allocation based on the bottleneck structure.

### CROSS-REFERENCE TO RELATED APPLICATION

The present application claims the benefit of U.S. Provisional Patent Application No. 63/262,644, filed on Oct. 18, 2021, and titled “USING BOTTLENECK STRUCTURES TO EFFICIENTLY COMPUTE INCREMENTAL PATHS IN MULTIPATH MAX-MIN BANDWIDTH ALLOCATION,” the disclosure of which is expressly incorporated by reference in its entirety.

### FIELD OF THE DISCLOSURE

Aspects of the present disclosure generally relate to networking systems and, in particular, to bandwidth allocation for flows with multipath networks.

### BACKGROUND

The problem of congestion control is one of the most widely studied areas in data networks. Many congestion control algorithms, including the bottleneck bandwidth and round-trip propagation time (BBR) algorithm recently proposed by Google, are known. The conventional view of the problem of congestion control in data networks has focused around the principle that a flow's performance is uniquely determined by the state of its bottleneck link. This view helped the Internet recover from congestion collapse in 1988, and throughout the more than 30 years of research and development that followed. A well-known example of the traditional single-bottleneck view is the Mathis equation, which can model the performance of a single TCP flow based on the equation

$$\frac{M S S}{RTT \cdot \sqrt{p}} ,$$

where MSS is the maximum segment size, RTT is the round trip time of the flow and p is the packet loss probability.

The problem of finding multipath max-min bandwidth allocations is known to be computationally hard to resolve. Existing solutions implement water-filling heuristics that yield suboptimal allocations. Because these solutions require performing a water-filling technique from scratch, attempting to find incremental directions in a search space that lead to higher performance solutions by making small network modifications (e.g., changing the path or the rate of a flow) on the current bandwidth allocation is very expensive.

### SUMMARY

Bottleneck links in congestion-controlled networks do not operate as independent resources, however. For instance, Mathis equation does not take into account the system-wide properties of a network, including its topology, the routing and the interactions between flows. In reality, bottleneck links generally operate according to a bottleneck structure described herein that can reveal the interactions of bottleneck links, and the system-wide ripple effects caused by perturbations in the network. Techniques using the bottleneck structure, such as the GradientGraph method described below, can address a gap in the analysis performed by the conventional techniques, and can provide an alternative methodology to estimate network flow throughput.

Specifically, we present a quantitative technique for expressing bottleneck structures, a mathematical and engineering framework based on a family of polynomial-time algorithms that can be used to reason and identify optimized solutions in a wide variety of networking problems, including network design, capacity planning, flow control and routing. For each of these applications, we present examples and experiments to demonstrate how bottleneck structures can be practically used to design and optimize data networks.

Accordingly, in one aspect a method is provided for analyzing/managing network flows. The method includes, performing by a processor, for a network having several links and several active flows during a specified time window, constructing a bottleneck structure. The bottleneck structure includes one or more link vertices respectively corresponding to one or more links and one or more flow vertices respectively corresponding to one or more flows. The bottleneck structure also includes one or more link-to-flow edges from a link vertex to one or more flow vertices, where the link-to-flow edges indicate that respective flows corresponding to the one or more flow vertices are bottlenecked at a link corresponding to the link vertex. The method also includes computing and storing, for each link vertex, a respective fair share of a corresponding link.

In some embodiments, the bottleneck structure includes one or more flow-to-link edges from a flow vertex to one or more link vertices, where a flow corresponding to the flow vertex traverses respective links corresponding to the respective link vertices, but that flow is not bottlenecked at the respective links. In other embodiments, the flow is bottlenecked at least at one of the network links and, as such, at least one of the one or more link-to-flow edges is or includes a bidirectional edge.

Constructing the bottleneck structure may include determining, for each link in the network, a number of flows bottlenecked at that link, and summing, over the plurality of links, the respective numbers of flows bottlenecked at each link, to obtain a total number of link-to-flow edges in the bottleneck structure. The method may further include allocating memory based on, at least in part, the total number of link-to-flow edges for the bottleneck structure. The overall memory allocation may additionally depend, at least in part, on the total number of link vertices, the total number of flow vertices, and the total number of flow-to-link edges. Since, for one or more links, all flows traversing such links may not be bottlenecked at those respective links, the total number of link-to-flow edges (or the total number of bidirectional link-to-flow edges) that are required may be minimized compared to a network graph structure having, for each link, and edge from a corresponding link vertex to vertices corresponding to all flows traversing the link. This can facilitate a memory efficient storage of the bottleneck structure.

In some embodiments, the method further includes selecting, from the plurality of flows, a flow to be accelerated and determining, by traversing the bottleneck structure, a target flow associated with a positive flow gradient. In addition, the method may include computing a leap and a fold for the target flow, where the fold includes at least two links having the same or substantially the same faire share. The method may also include reducing flow rate of the target flow using a traffic shaper by a factor up to the leap, and increasing flow rate of the flow to be accelerated up to a product of the leap and a gradient of the flow to be accelerated. The factor may be selected to preserve completion time of slowest of the flows in the network. The method may include repeating the determining, computing, reducing, and increasing steps.

The bottleneck structure may include several levels, including a first level of link vertices and a second, lower level of link vertices, where the flows associated with (e.g., bottlenecked at) the lower level of link vertices may generally have higher rates. The method may include, for adding a new flow to the network, designating the new flow to at least one link of the second level, regardless of whether that link is a part of the shortest path for the flow to be added, to improve flow performance.

The method may include selecting, from the links in the network, a link for which capacity is to be increased, computing a leap of a gradient of the selected link, and increasing capacity of the selected link by up to the leap, to improve network performance. The network may include a data network, a transportation network, an energy distribution network, a fluidic network, or a biological network.

In another aspect, a system is provided for analyzing/managing network flows. The system includes a first processor and a first memory in electrical communication with the first processor. The first memory includes instructions that, when executed by a processing unit that includes one or more computing units, where one of such computing units may include the first processor or a second processor, and where the processing unit is in electronic communication with a memory module that includes the first memory or a second memory, program the processing unit to: for a network having several links and several active flows during a specified time window, constructing a bottleneck structure.

The bottleneck structure includes one or more link vertices respectively corresponding to one or more links and one or more flow vertices respectively corresponding to one or more flows. The bottleneck structure also includes one or more link-to-flow edges from a link vertex to one or more flow vertices, where the link-to-flow edges indicate that respective flows corresponding to the one or more flow vertices are bottlenecked at a link corresponding to the link vertex. The instructions also configure the processing unit to compute and store, for each link vertex, a respective fair share of a corresponding link. In various embodiments, the instructions can program the processing unit to perform one or more of the method steps described above.

In another aspect, a method is provided for analyzing/managing a network. The method includes performing by a processor the steps of: obtaining network information and determining a bottleneck structure of the network, where the network includes several links and several flows. The method also includes determining propagation of a perturbation of a first flow or link using the bottleneck structure, and adjusting the first flow or link, where the adjustment results in a change in a second flow or link, where the change is based on the propagation of the perturbation or the adjustment to the first flow or link.

The network may include a data network, a transportation network, an energy distribution network, a fluidic network, or a biological network. Determining the propagation may include computing a leap and a fold associated with the first flow or link, and adjusting the first flow or link may include increasing or decreasing a rate of the first flow or increasing or decreasing allotted capacity of the first link.

In another aspect, a system is provided for analyzing/managing a network. The system includes a first processor and a first memory in electrical communication with the first processor. The first memory includes instructions that, when executed by a processing unit that includes one or more computing units, where one of such computing units may include the first processor or a second processor, and where the processing unit is in electronic communication with a memory module that includes the first memory or a second memory, program the processing unit to: obtain network information and determine a bottleneck structure of the network, where the network includes several links and several flows.

The instructions also program the processing unit to determine propagation of a perturbation of a first flow or link using the bottleneck structure, and to adjust or direct adjusting of the first flow or link, where the adjustment results in a change in a second flow or link, and where the change is based on the propagation of the perturbation or the adjustment to the first flow or link. In various embodiments, the instructions can program the processing unit to perform one or more of the method steps described above.

In aspects of the present disclosure, a processor-implemented method includes computing a bandwidth allocation for a number of flows in a number of flow groups. Pairs of nodes in a network transmit data to each other via at least one of the number of flows in one of the flow groups. Each of the flows traverses a path comprising a number of network links. The method also includes building a bottleneck structure graph for the flow groups. The method further includes calculating a network allocation based on the bottleneck structure.

Other aspects of the present disclosure are directed to an apparatus. The apparatus has a memory and one or more processors coupled to the memory. The processor(s) is configured to compute a bandwidth allocation for a number of flows in a number of flow groups. Pairs of nodes in a network transmit data to each other via at least one of the flows in one of the flow groups. Each of the flows traverses a path comprising a number of network links. The processor(s) is also configured to build a bottleneck structure graph for the number of flow groups. The processor(s) is further configured to calculate a network allocation based on the bottleneck structure.

Other aspects of the present disclosure are directed to an apparatus. The apparatus includes means for computing a bandwidth allocation for a number of flows in a number of flow groups. Pairs of nodes in a network transmit data to each other via at least one of the flows in one of the flow groups. Each of the flows traverses a path comprising a number of network links. The apparatus also includes means for building a bottleneck structure graph for the flow groups. The apparatus further includes means for calculating a network allocation based on the bottleneck structure.

In other aspects of the present disclosure, a non-transitory computer-readable medium with program code recorded thereon is disclosed. The program code is executed by a processor and includes program code to compute a bandwidth allocation for a number of flows in a number of flow groups. Pairs of nodes in a network transmit data to each other via at least one of the flows in one of the flow groups. Each of the flows traverse a path comprising a number of network links. The program code also includes program code to build a bottleneck structure graph for the flow groups. The program code still further includes program code to calculate a network allocation based on the bottleneck structure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

The present disclosure will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the invention. In the drawings:

FIGS. 1A and 1B show different embodiments of a procedure to construct a bottleneck structure used in analysis and manipulation of a network.

FIGS. 2A and 2B illustrate analysis of bottleneck links and bottleneck flows, according to various aspects.

FIGS. 2C and 2D illustrate computation of gradients for the links and flows depicted in FIGS. 2A and 2B, according to various aspects.

FIG. 3 presents a procedure to determine leaps and folds associated with flows and links, according to various aspects.

FIG. 4 presents a procedure to optimize a flow using flow and link gradients, according to various aspects.

FIG. 5 depicts one topology of an example network.

FIGS. 6A-6C show a sequence of bottleneck structures generated using various aspects of the procedure depicted in FIG. 4.

FIG. 7 depicts another topology of the example network shown in FIG. 5.

FIG. 8A shows a bottleneck structure of the network shown in FIG. 7.

FIGS. 8B and 8C show bottleneck structures of the network upon adding a flow to the network, according to different aspects.

FIG. 9 depicts an example fat-tree network topology.

FIGS. 10A-10C depict different bottleneck structures resulting from allotting, according to different aspects, different link capacities of certain links of the network of FIG. 9.

FIGS. 11 and 12 illustrate bandwidth allocation with a greedy algorithm, in accordance with various aspects of the present disclosure.

FIGS. 13 and 14 illustrate bottleneck structures, in accordance with various aspects of the present disclosure.

FIG. 15 is a flow diagram illustrating a processor-implemented method, in accordance with various aspects of the present disclosure.

### DETAILED DESCRIPTION

While it is generally true that a flow's performance is limited by the state of its bottleneck link, we recently discovered how bottlenecks in a network interact with each other through a structure—which we call the bottleneck structure—that depends on the topological, routing and flow control properties of the network. A related structure is described in co-pending U.S. patent application Ser. No. 16/580,718, titled “Systems and Methods for Quality of Service (Qos) Based Management of Bottlenecks and Flows in Networks,” filed on Sep. 24, 2019, which is incorporated herein by reference. U.S. patent application Ser. No. 16/580,718 (which may also refer to the graph structure described therein as a bottleneck structure), generally describes qualitative properties of the bottleneck precedence graph (BPG), a structure that analyzes the relationships among links.

In the discussion below, we introduce a new bottleneck structure called the gradient graph. One important difference between the gradient graph and the BPG is that the gradient graph also describes the relationships among flows and links, providing a more comprehensive view of the network. Another important difference is that the gradient graph enables a methodology to quantify the interactions among flows and links, resulting in a new class of techniques and algorithms to optimize network performance. The bottleneck structure describes how the performance of a bottleneck can affect other bottlenecks, and provides a framework to understand how perturbations on a link or flow propagate through a network, affecting other links and flows. If the congestion control problem for data networks were an iceberg, the traditional single-bottleneck view would be its tip and the bottleneck structure would be its submerged portion, revealing how operators can optimize the performance of not just a single flow but of the overall system-wide network.

Thus, we present herein a quantitative theory of bottleneck structures, a mathematical framework and techniques that results in a set of polynomial time algorithms that allow us to quantify the ripple effects of perturbations in a network. Perturbations can either be unintentional (such as the effect of a link failure or the sudden arrival of a large flow in a network) or intentional (such as the upgrade of a network link to a higher capacity or the modification of a route with the goal of optimizing performance). With the framework described herein, a network operator can quantify the effect of such perturbations and use this information to optimize network performance.

In particular:

A new generalized bottleneck structure called gradient graph is introduced, which captures the space-solution of a congestion control algorithm and provides a framework to quantify the effects of perturbations in the network. A polynomial-time algorithm to compute the gradient graph is presented. (Section 2.2.)

The concepts of link and flow gradient are introduced. These operators quantify the effects of infinitesimally small perturbations in a network. A linear-time technique to compute the gradients is presented. (Section 2.3.)

The concepts of leap and fold are presented, which allow us to compute the effect that perturbations of arbitrary size have on a network. This leads to a polynomial-time algorithm for traveling along the solution space of a congestion control problem. We show how this procedure can be used to reconfigure networks to a higher performance operational point. (Section 2.4.)

Examples demonstrating the applications of the proposed framework are provided. These include applications in the areas of capacity planning, network design, flow control and routing. (Section 3.)

Experiments on TCP/IP networks are provided, demonstrating the validity of the framework described herein. These experiments include tests with bottleneck bandwidth and round-trip propagation time (BBR) and Cubic congestion control algorithms. (Section 4.)

The techniques described herein are generally applicable to networks that transport commodity flows. In addition to communication networks, examples include (but are not limited to) vehicle networks, energy networks, fluidic networks, and biological networks. For example, the problem of vehicle networks generally involves identifying optimized designs of the road system that allows for a maximal amount of vehicles that can circulate through the network without congesting it or, similarly, minimizing the level of congestion for a given amount of circulating vehicles. In this case, vehicles are analogous to packets in a data network, while flows correspond to the set of vehicles going from location A to location B at a given time that follow the same path.

The capacity planning techniques described below can be used to analyze the need to construct a road to mitigate congestion hotspots, compute the right amount of capacity needed for each road segment, and to infer the projected effect on the overall performance of the road system. Similarly, the routing techniques described below can be used to suggest drivers alternative paths to their destination that would yield higher throughput or, equivalently, lower their destination arrival time.

The problem of energy networks generally includes transporting energy from the locations where energy is generated to the locations where it is consumed. For instance, energy can be in the form of electricity carried via the electrical grid. Other examples include fluidic networks, which can carry crude oil, natural gas, water, etc., or biological networks that may carry water, nutrients, etc.

Biological networks, through evolution, may tend to organize themselves in optimized structures that maximize their performance (in terms of transporting nutrients) and/or minimize the transportation costs. For instance, a tree transports sap from the root to its branches and in both directions. The sap transported from the root to its branches and leaves is called xylem, which carries energy and nutrients found from the soil where the tree is planted. The sap transported from the leaves and branches to the root is called phloem, which carries also important nutrients obtained from the biochemical process of photosynthesis performed in the cells of the leaves. In both networks (upward and downward), it is likely that the network transporting the sap performs optimally in terms of minimizing the amount of energy required to transport a given amount of sap. Such optimized designs can be generated for other types of networks, using the bottleneck structures and perturbation propagation based thereon, as discussed below. Biological networks can themselves be optimized based on such analysis.

2 Theoretical Framework

2.1 Network Model

In their simplest form, networks are systems that can be modeled using two kinds of elements: links, which offer communication resources with a limited capacity; and flows, which make use of such communication resources. We formalize the definition of network as follows:

Definition 1 Network. We say that a tuple [symbol] = [symbol] [symbol] , [symbol] , {cₗ, [symbol] l∈ [symbol] } [symbol] is a network if:

[symbol] is a set of links of the form {l₁, l₂, . . . , [symbol] },

[symbol] is a set of flows of the form {f₁, f₂, . . . , [symbol] }, and

cₗ is the capacity of link l, for all l∈ [symbol] .

Each flow f traverses a subset of links [symbol] _{f}⊂ [symbol] and, similarly, each link l is traversed by a subset of flows [symbol] ₗ⊂ [symbol] . We will also adopt the convenient notation f= [symbol] _{f} and l=Fₗ. That is, a flow is the list of links that it traverses and a link is the list of flows that traverse it. Finally, each flow f transmits data at a rate r_{f} and the capacity constraint Σ_{∀f∈l}r_{f}≤cₗ must hold for all l∈ [symbol] .

A core concept upon which our framework resides is the notion of a bottleneck link. Intuitively, a link in a network is a bottleneck if its capacity is fully utilized. Mathematically and in the context of this work, we will use a more subtle definition:

Definition 2 Bottleneck link. Let [symbol] = [symbol] [symbol] , [symbol] , {cₗ, [symbol] l∈ [symbol] } [symbol] be a network where each flow f∈ [symbol] transmits data at a rate r_{f} determined by a congestion control algorithm (e.g., TCP's algorithm). We say that flow f is bottlenecked at link l—equivalently, that link l is a bottleneck to flow f—if and only if.

Flow f traverses link l, and

$$\frac{\partial {r}_{f}}{\partial {c}_{l}} \neq 0 .$$

That is, the transmission rate of flow f changes upon small changes of link l's capacity.

This definition of bottleneck generalizes some of the classic definitions found in the literature, while differing from them in that it focuses on the notion of perturbation, mathematically expressed as a derivative of a flow rate with respect to the capacity of a link,

$$\frac{\partial {r}_{f}}{\partial {c}_{l}} .$$

(As an example to illustrate that our definition of bottleneck is relatively flexible, in Section 7.1 we show that it corresponds to a generalization of the classic max-min definition.) The general character of the bottleneck definition used in various embodiments described herein is relevant in that it makes our framework applicable not just to specific rate allocation assignments (e.g., max-min, proportional fairness, etc.) or to specific congestion control algorithms (e.g., BBR, Cubic, Reno, etc.), but to any class of congestion control solutions, such as those available in today's networks and those may be developed subsequently, provided that the two conditions in Definition 2 hold.

We complete the description of the network model introducing the concept of fair share:

Definition 3 Fair share of a link. Let [symbol] = [symbol] [symbol] , [symbol] , {cₗ, [symbol] l∈ [symbol] } [symbol] be a network. The fair share sₗ of a link l∈ [symbol] is defined as the rate of the flows that are bottlenecked at such link.

The flows bottlenecked at a link may all have the same rate that may be the same as the faire share of the link. As used throughout the discussion below, the concept of link fair share is dual to the concept of flow rate. That is, all the mathematical properties that are applicable to the rate of a flow, are also applicable to the fair share of a link.

2.2 The Gradient Graph

Our objective is to derive a mathematical framework capable of quantifying the effects that perturbations on links and flows exert on each other. Because the bottleneck structure described in U.S. patent application Ser. No. 16/580,718 considers only the effects between bottleneck links, we need a generalization of such structure that can also describe the effects of perturbations on flows. We refer to this data structure as the gradient graph, formally defined as follows (the name of this graph derives from the fact that perturbations can mathematically be expressed as derivatives or, more generically, as gradients):

Definition 4A Gradient graph. The gradient graph is a digraph such that:

1. For every bottleneck link and for every flow, there exists a vertex.

2. For every flow f:

(a) If f is bottlenecked at link l, then there exists a directed edge from l to f;

(b) If f is not bottlenecked at link l but it traverses it, then there exists a directed edge from f to l.

We may also employ a variation of the Definition 4A as:

Definition 4B Gradient graph. The gradient graph is a digraph such that:

1. For every bottleneck link and for every flow, there exists a vertex.

2. For every flow f:

(a) If f is bottlenecked at link l, then there exists a directed edge from l to f;

(b) If f traverses link l, then there exists a directed edge from f to l.

By way of notation, in the discussion below we will use the terms gradient graph and bottleneck structure indistinguishably. Intuitively, a gradient graph describes how perturbations on links and flows propagate through a network as follows. A directed edge from a link l to a flow f indicates that flow f is bottlenecked at link l (Condition 2(a) in Definitions 4A and 4B). A directed edge from a flow f to a link l indicates that flow f traverses but is not bottlenecked at link l (Condition 2(b) in Definition 4A), and a bidirectional edge from a flow f to a link l indicates that flow f traverses (and is bottlenecked at) link l (Condition 2(b) in Definition 4B).

From Definition 2, this necessarily implies that a perturbation in the capacity of link l will cause a change on the transmission rate of flow f,

$$\frac{\partial {r}_{f}}{\partial {c}_{l}} \neq 0 .$$

A change in the value of r_{f}, in turn, creates a perturbation that propagates to all the other links traversed by flow f, following the direction of those edges departing from flow f and arriving at such links (Conditions 2(b) in Definitions 4A or 4B). This basic process of (1) inducing a perturbation in a vertex in a graph (either in a link or a flow vertex) followed by (2) propagations in the departing edges of the vertex, creates a ripple effect in the bottleneck structure, terminating at the leaves of the gradient graph.

The relevancy of the gradient graph as a data structure to help understand network performance is captured in the following lemma, which mathematically describes how perturbations propagate through a network.

Lemma 1 Propagation of network perturbations.

1. The following characterizes the propagation of a perturbation in a bottleneck link:

(a) A perturbation in a link l induced by a change on its capacity cₗ will propagate to another link l′ affecting its fair share s_{l′} if and only if l′ is a descendant of l in the gradient graph.

(b) A perturbation in a link l induced by a change on its capacity cₗ will propagate to a flow f affecting its transmission rate r_{f} if and only if f is a descendant of l in the gradient graph.

2. Let f be a flow bottlenecked at link l. The following characterizes the propagation of a perturbation in a flow:

(a) A perturbation in f induced by a change on its transmission rate r_{f} will propagate to a link l′ affecting its fair share s_{l′} if and only if l′ is a descendant of l in the gradient graph.

(b) A perturbation in f induced by a change on its transmission rate r_{f} will propagate to a flow f′ affecting its transmission rate r_{f′} if and only if f′ is a descendant of l in the gradient graph.

Proof See Section 7.2.

Leveraging Lemma 1, we are now in a position to formally define the regions of influence of a data network.

Definition 5 Regions of influence in a data network. We define the region of influence of a link l, denoted as [symbol] (l), as the set of links and flows that are affected by a perturbation in the capacity cₗ of link l, according to Lemma 1. Similarly, we define the region of influence of a flow f, denoted as [symbol] (f), as the set of links and flows that are affected by a perturbation in the transmission rate r_{f} of flow f, according to Lemma 1.

From Lemma 1, we know that the region of influence of a link (or a flow) corresponds to its descendants in the gradient graph. Such regions are relevant to the problem of network performance analysis and optimization because they describe what parts of a network are affected by perturbations on the performance of a link (or a flow). In Section 2.3, it is discussed how such influences can be quantified using the concept of link and flow gradient.

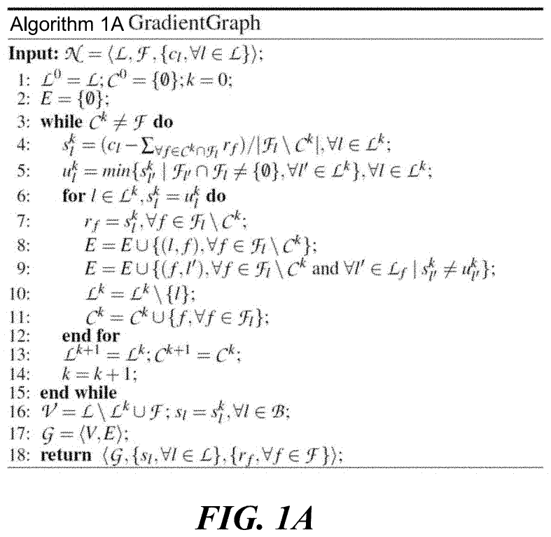

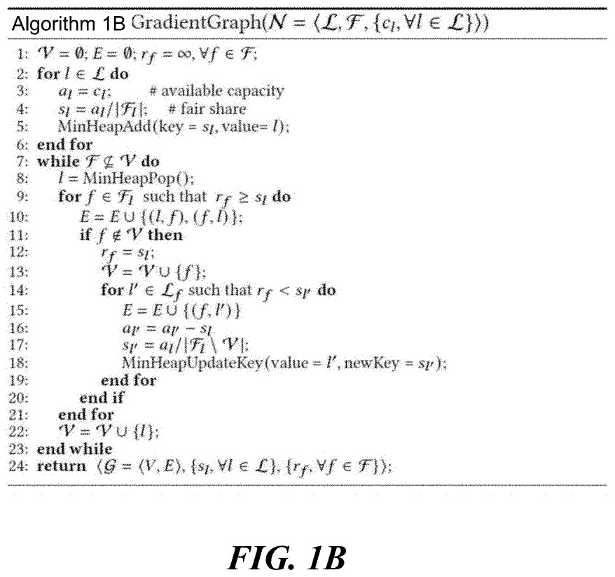

We can now introduce the GradientGraph (Algorithm 1A, FIG. 1A), an embodiment of a procedure that computes the gradient graph of a network. The algorithm works as follows. In line 4, a fair share (Definition 3) estimate of each link is computed. Lines 5 and 6 select all links that currently have the smallest fair share among those links with which they share a flow. For each of these links: (1) all the flows remaining in the network that traverse them are assigned the fair share of the link (line 7), removed from the network (line 10) and put into the set of flows that have converged to their theoretical transmission rate [symbol] ^{k} (line 11); (2) the link itself is also removed (line 10); and (3) directed edges are added to the gradient graph that go from the link to all the flows bottlenecked at it (line 8) and from each of these flows to the rest of the links that they traverse (line 9). This iterative process is repeated until all flows have converged to their theoretical rate (line 3). The algorithm returns the gradient graph [symbol] , the fair share of each link {sₗ, [symbol] l∈ [symbol] } and the rate of each flow {r_{f}, [symbol] f∈ [symbol] }.

Lemma 2A states the time complexity of the GradientGraph algorithm:

Lemma 2A Time complexity of the GradientGraph algorithm. The time complexity of running GradientGraph( ) is O(H·| [symbol] |²+| [symbol] |·| [symbol] |), where H is the maximum number of links traversed by any flow.

Proof See Section 7.4.1

FIG. 1B shows another embodiment of GradientGraph (Algorithm 1B). In this embodiment, the algorithm begins with crude estimates of the fair share rates of the links, and iteratively refines them until all the capacity in the network has been allocated and the rate of each flow reaches its final value. In the process, the gradient graph is constructed level by level. The algorithm starts by initializing the available capacity of each link (line 3), estimating its fair share (line 4) and adding all links to a min-heap by taking their fair share value as the key (line 5). At each iteration, the algorithm picks the unresolved link with the lowest fair share value from the min-heap (line 8).

Once this link is selected, all unresolved flows remaining in the network that traverse it are resolved. That is, their rates are set to the fair share of the link (line 12) and they are added to the set of vertices of the gradient graph V (line 13). In addition, directed edges are added in the gradient graph between the link and all the flows bottlenecked at it (line 10) and from each of these flows to the other links that they traverse (line 15). Lines 16-17-18 update the available capacity of the link, its fair share, and the position of the link in the min-heap according to the new fair share. Finally, the link itself is also added as a vertex in the gradient graph (line 22). This iterative process may be repeated until all flows have been added as vertices in the gradient graph (line 7). The algorithm returns the gradient graph G, the fair share of each link {sₗ, [symbol] l∈ [symbol] } and the rate of each flow {r_{f}, [symbol] f∈ [symbol] }.

Lemma 2B provides the run-time complexity of this embodiment of the GradientGraph( ) algorithm:

Lemma 2B. Time complexity of GradientGraph( ). The time complexity of running GradientGraph( ) is O(|L| log |L|·H), where H is the maximum number of flows that traverse a single link.

Proof See Section 7.4.2.

The GradientGraph is memory efficient, as well. In particular, various embodiments of the GradientGraph include a respective vertex for each link and a respective vertex for each flow. As such, the number of vertices in a GradientGraph is O(| [symbol] |+| [symbol] |). The edges in the graph from a link vertex to one or more flow vertices do not include, however, an edge to each and every flow vertex where that flow vertex represents a flow traversing the link corresponding to the link vertex. Rather, edges exist from a link vertex to a flow vertex only if, as described above, a flow corresponding to that flow vertex is bottlenecked at the link corresponding to the link vertex. This minimizes the total number of edges in various embodiments and implementations of GradientGraph.

Since the memory required to construct a GradientGraph is a function of (e.g., proportional to the total number of vertices and the total number of edges, the identification of the bottleneck structure facilitates efficient memory allocation in various embodiments. Specifically, in some cases, the memory to be allocated can be a function of the total number of link vertices to flow vertices edges, denoted (|E_{b}^{l→f}|) where |E_{b}^{l→f}| is a sum of the number of bottlenecked flows at each link. The required memory may be proportional to O(| [symbol] |+| [symbol] |+|E|), where the set {E} includes the set of edges from flow vertices to link vertices, denoted {E^{f→l}} and the set of edges from link vertices to flow vertices corresponding to bottlenecked flows, denoted {E^{l→f}}. In some cases, the total number of flows bottlenecked at a link l is less than the total number of flows traversing the link l, minimizing the number of edges |E^{l→f}|.

Since, for one or more links, all flows traversing such links may not be bottlenecked at those respective links, the total number of link-to-flow edges (or the total number of bidirectional link-to-flow edges) that are required may be minimized compared to a network graph structure having, for each link, and edge from a corresponding link vertex to vertices corresponding to all flows traversing the link. This can facilitate a memory efficient storage of the gradient graph. Thus, the derivation of the bottleneck structure can minimize the memory required to store and manipulate such a structure, in various embodiments.

2.3 Link and Flow Gradients

In this section, we focus on the problem of quantifying the ripple effects created by perturbations in a network. Because networks include links and flows, generally there are two possible causes of perturbations: (1) those originating from changes in the capacity of a link and (2) those originating from changes in the rate of a flow. This leads to the concept of link and flow gradient, formalized as follows:

Definition 6 Link and flow gradients. Let [symbol] = [symbol] [symbol] , [symbol] , {cₗ, [symbol] l∈ [symbol] } [symbol] be a network. We define:

The gradient of a link l*∈ [symbol] with respect to some other link l∈ [symbol] , denoted with ∇_{l*}(l), as

$${∇}_{{l}^{*}} ( l ) = \frac{\partial {s}_{l}}{\partial {c}_{{l}^{*}}} .$$

The gradient of a link l*∈ [symbol] with respect to some flow f∈ [symbol] , denoted with ∇_{l*}(f), as

$${∇}_{{l}^{*}} ( f ) = \frac{\partial {r}_{f}}{\partial {c}_{{l}^{*}}} .$$

The gradient of a flow f*∈ [symbol] with respect to some link l∈ [symbol] , denoted with ∇_{f*}(l), as

$${∇}_{{f}^{*}} ( l ) = \frac{\partial {s}_{l}}{\partial {r}_{{f}^{*}}} .$$

The gradient of a flow f*∈ [symbol] with respect to some other flow f∈ [symbol] , denoted with ∇_{f*}(f),

$${∇}_{{f}^{*}} ( f ) = \frac{\partial {r}_{f}}{\partial {r}_{{f}^{*}}} .$$

Intuitively, the gradient of a link measures the impact that a fluctuation on the capacity of a link has on other links or flows. In real networks, this corresponds to the scenario of physically upgrading a link or, in programmable networks, logically modifying the capacity of a virtual link. Thus, link gradients can generally be used to resolve network design and capacity planning problems. Similarly, the gradient of a flow measures the impact that a fluctuation on its rate has on a link or another flow. For instance, this scenario corresponds to the case of traffic shaping a flow to alter its transmission rate or changing the route of a flow—which can be seen as dropping the rate of that flow down to zero and adding a new flow on a different path. Thus, flow gradients can generally be used to resolve traffic engineering problems. (In Section 3 applications in real networks that illustrate each of these scenarios are provided.)

Before describing how link and flow gradients can be efficiently computed using the gradient graph, we introduce the concept of flow drift:

Definition 7 Drift. Let [symbol] = [symbol] [symbol] , [symbol] , {cₗ, [symbol] l∈ [symbol] } [symbol] be a network and assume [symbol] [symbol] , {sₗ, [symbol] l∈ [symbol] }, {r_{f}, [symbol] f∈ [symbol] } [symbol] is the output of GradientGraph( [symbol] ) (Algorithms 1A or 1B). Let δ be an infinitesimally small perturbation performed on the capacity of a link l*∈ [symbol] π(equivalently, on the rate of a flow f*∈ [symbol] ). Let also sₗ+Δₗ and r_{f}+Δ_{f} be the fair share of any link l∈ [symbol] and the rate of any flow f∈ [symbol] , respectively, after the perturbation δ has propagated through the network. We will call Δₗ and Δ_{f} the drift of a link l and a flow f, respectively, associated with perturbation δ.

Intuitively, the drift corresponds to the change of performance experienced by a link or a flow when another link or flow is perturbed. Using this concept, the following lemma describes how the gradient graph structure introduced in Definition 4 encodes the necessary information to efficiently calculate link and flow gradients in a network:

Lemma 3 Gradient graph invariants. Let [symbol] = [symbol] [symbol] , [symbol] , {cₗ, [symbol] l∈ [symbol] } [symbol] be a network and let [symbol] be its gradient graph. Let δ be an infinitesimally small perturbation performed on the capacity of a link l*∈ [symbol] (equivalently, on the rate of a flow f*∈ [symbol] ) and let Δₗ and Δ_{f} be the drifts caused on a link l∈ [symbol] and a flow f∈ [symbol] , respectively, by such a perturbation. Assume also that the perturbation propagates according to the gradient graph [symbol] by starting on the link vertex l* (equivalently, on the flow vertex f*) and following all possible directed paths that depart from it, while maintaining the following invariants at each traversed vertex:

Invariant 1: Link equation.

$${Δ}_{l} = - \frac{{\sum }_{1 \leq i \leq m} {Δ}_{{f}_{i}}}{n} ,$$

where Δ_{f}_{ᵢ}, . . . , Δ_{f}_{ₘ} are the flow drifts entering link vertex l and n is its outdegree.

Invariant 2: Flow equation. Δ_{f}=min{Δₗ_{ᵢ}, 1≤i≤m}, where Δₗ_{ᵢ}, . . . , Δₗ_{ₘ} are the link drifts entering flow vertex f.

Let also [symbol] ′ be the gradient graph of the resulting network after the perturbation has propagated. Then, if [symbol] = [symbol] ′, the link and flow gradients can be computed as follows:

$${∇}_{l} ( l ) = \frac{\partial {s}_{l}}{\partial {c}_{{l}^{*}}} = \frac{{Δ}_{l}}{δ} ; {∇}_{{l}^{*}} ( f ) = \frac{\partial {r}_{f}}{\partial {c}_{{l}^{*}}} = \frac{{Δ}_{f}}{δ} ; {∇}_{{f}^{*}} ( l ) = \frac{\partial {s}_{l}}{\partial {r}_{{f}^{*}}} = \frac{{Δ}_{l}}{δ} ; {∇}_{{f}^{*}} ( f ) = \frac{\partial {r}_{f}}{\partial {r}_{{f}^{*}}} = \frac{{Δ}_{f}}{δ} .$$

Proof See Section 7.3.

The previous lemma states that if the gradient graph does not change its structure upon a small perturbation (i.e., [symbol] = [symbol] ′) and the two invariants are preserved, then such a perturbation can be measured directly from the graph. The first invariant ensures that (1) the sum of the drifts arriving to and departing from a link vertex are equal to zero and (2) the drifts departing from a link vertex are equally distributed. Intuitively, this is needed to preserve the congestion control algorithm's objective to maximize network utilization while ensuring fairness among all flows. The second invariant is a capacity feasibility constraint, ensuring that a flow's drift is limited by its most constrained bottleneck.

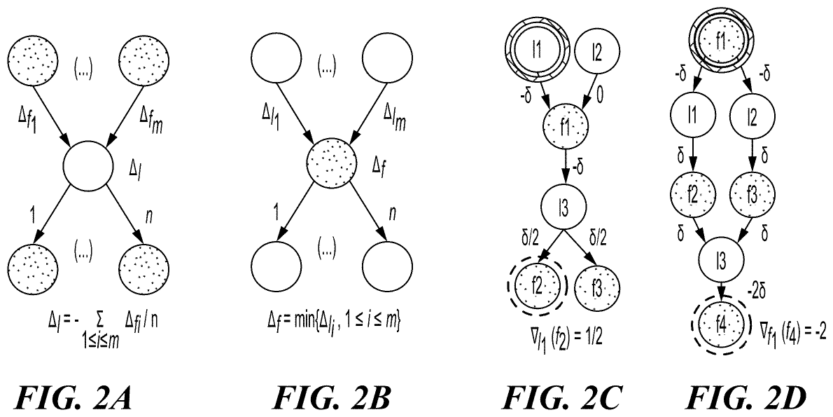

FIGS. 2A and 2B show a graphical interpretation of the link and flow equations. FIG. 2C illustrates an example to compute the link gradient ∇ₗ_{₁}(f₂). A perturbation is applied to link l₁ that decreases its capacity cₗ_{₁}, by an infinitesimally small amount δ. such a perturbation propagates to flow f₁ according to the flow equation (Δ_{f}=min{Δₗ_{ᵢ}, 1≤i≤m}), resulting in a drift Δ_{f}_{₁}=−δ. The perturbation is further propagated down to link l₃. Applying the link equation

$${Δ}_{l} = - \frac{{\sum }_{1 \leq i \leq m} {Δ}_{{f}_{i}}}{n} ) ,$$

this generates a drift on this link of

$${Δ}_{{l}_{3}} = \frac{δ}{2} .$$

Applying again the flow equation on f₂, we obtain the flow drift

$${Δ}_{{f}_{2}} = \frac{δ}{2} .$$

Thus, using Lemma 3, the gradient of link l₁ with respect to flow f₂ is

$${∇}_{{l}_{1}} ( {f}_{2} ) = \frac{{Δ}_{{f}_{2}}}{δ} = \frac{1}{2} .$$

FIG. 2D illustrates an example of flow gradient computation which shows that for this bottleneck structure, the gradient of flow f₁ with respect to flow f₄ is ∇_{f}_{₁}(f₄)=−2.

It should be noted that it is feasible for a link or flow gradient to have a value larger than 1. Such gradients are of interest because they mean that an initial perturbation of one unit at some location of a network, generates a perturbation at another location of more than one unit. For instance, a gradient of the form ∇_{f*}(f)>1 implies that reducing the rate of flow f* by one unit creates a perturbation that results in an increase on the rate of flow f by more than one unit, thus creating a multiplicative effect. Such gradients can be used to identify arbitrage situations—e.g., configurations of the network that increase the total flow of a network. Because of their relevance, we will use the term power gradient to refer to such effect:

Definition 8 Power gradient. Let [symbol] = [symbol] [symbol] , [symbol] , {cₗ, [symbol] l∈ [symbol] } [symbol] be a network and let δ be an infinitesimally small perturbation performed on a flow or link x∈ [symbol] ∪ [symbol] , producing a drift Δ_{y}, for all y∈ [symbol] ∪ [symbol] . If Δ_{y}>δ, equivalently ∇ₓ(y)>1, then we will say that ∇ₓ(y) is a power gradient. In Section 3, we provide examples of power gradients. For now, we conclude this section stating a property of boundedness that all gradients in congestion-controlled networks satisfy:

Property 1 Gradient bound. Let [symbol] = [symbol] [symbol] , [symbol] , {cₗ, [symbol] l∈ [symbol] } [symbol] be a network and let G be its gradient graph. Let δ be an infinitesimally small perturbation performed on a flow or link x∈ [symbol] ∪ [symbol] , producing a drift Δ_{y}, for all y∈ [symbol] ∪ [symbol] . Then,

$${∇}_{x} ( y ) = \frac{{Δ}_{y}}{δ} \leq {d}^{\frac{D ( 𝒢 )}{4}} ,$$

where D(X) is the diameter function of a graph X and d is the maximum indegree and outdegree of any vertex in the graph.

Proof See Section 7.5.

2.4 Leaps and Folds

The concepts of link and flow gradients introduced in the previous section provide a methodology to measure the effect of perturbations on a network that are small enough (infinitesimally small) to avoid a structural change in the gradient graph (see Lemma 3). In this section, we introduce the concepts of leap and fold, which allow us to generalize the framework to measure perturbations of arbitrary sizes. Two simple and intuitive examples of such kind of perturbations found in real networks include: a link failure, which corresponds to the case its capacity goes down to zero; or the re-routing of a flow, which corresponds to the case its rate goes down to zero and a new flow is initiated.

From Lemma 3, we know that if a perturbation in the network is significant enough to modify the structure of the gradient graph (i.e., [symbol] ≠ [symbol] ′), then the link and flow equations (FIGS. 2A and 2B) cannot be used to compute the gradients of such a perturbation. In this section, we present a technique that can be used to measure perturbations of arbitrary sizes by using the concepts of leap and fold:

Definition 9 Gradient leap. Let ∇ₓ(y) be a gradient resulting from an infinitesimally small perturbation δ on a link or flow x, where x, y∈ [symbol] ∪ [symbol] . Suppose that we intensify such a perturbation by a factor k, resulting in an actual perturbation of λ=k·δ, for some k>0. Further, assume that k is the largest possible value that keeps the structure of the gradient graph invariant upon perturbation λ. Then, we will say that λ is the leap of gradient ∇ₓ(y).

The following lemma shows the existence of folds in the bottleneck structure when its corresponding network is reconfigured according to the direction indicated by a gradient and by an amount equal to its leap:

Lemma 4 Folding links. Let [symbol] = [symbol] [symbol] , [symbol] , {cₗ, [symbol] l∈ [symbol] } [symbol] be a network and let [symbol] be its gradient graph. Let λ be the leap of a gradient ∇ₓ(y), for some x, y∈ [symbol] ∪ [symbol] . Then, there exist at least two links l and l′ such that: (1) for some f∈ [symbol] , there is a directed path in [symbol] of the form l→f→l′; and (2) sₗ=s_{l′} after the perturbation has propagated through the network.

Proof See Section 7.6.

Intuitively, the above lemma states that when a perturbation is large enough to change the structure of the gradient graph, such structural change involves two links l and l′ directly connected via a flow f (i.e., forming a path l→f→l′) that have their fair shares collapse on each other (s′ₗ=s′_{l′}) after the perturbation has propagated. The faire shares can be substantially or approximately equal (e.g., the difference between the faire shares can be zero or less than a specified threshold, e.g., 10%, 5%, 2%, 1%, or even less of the fair share of one of the links.) Graphically, this corresponds to the folding of two consecutive levels in the bottleneck structure. We can now formalize the definition of fold as follows.

Definition 10 Fold of a gradient. Let λ be the leap of a gradient ∇_{X}(y), for some x, y∈ [symbol] ∪ [symbol] , and let l and l′ be two links that fold once the perturbation λ has propagated through the network (note that from Lemma 4, such links must exist). We will refer to the tuple (l, l′) as a fold of gradient ∇_{X}(y).

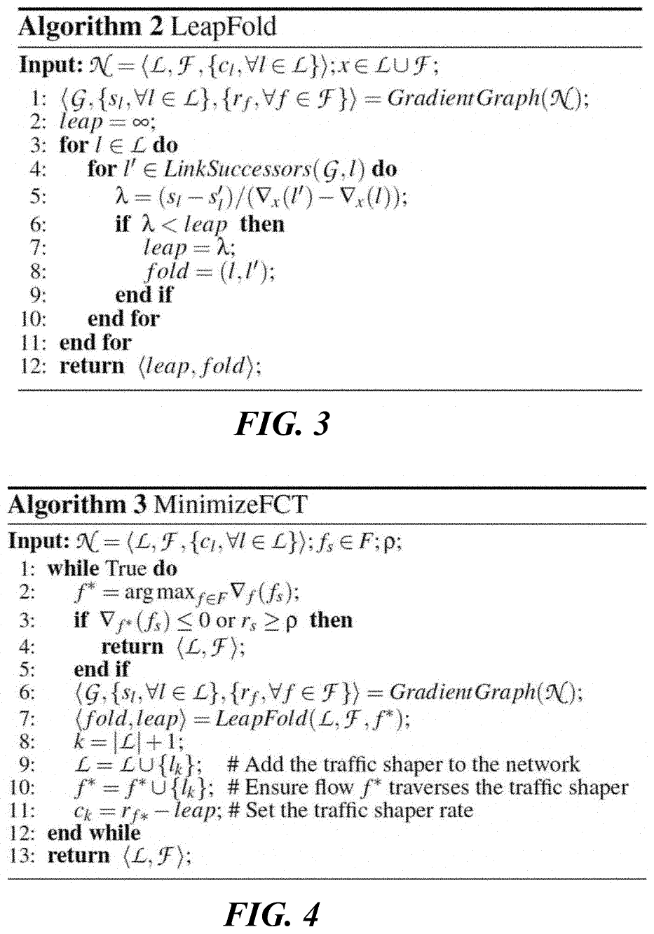

Algorithm 2 shown in FIG. 3 introduces LeapFold( ), a procedure to compute the leap and the fold of a link or flow gradient. Intuitively, for each pair of link vertices l and l′ in the bottleneck structure that are directly connected via a flow vertex (in line 4, l′ is a link successor of l), we compute the maximum amount λ that can be traveled along the gradient without the collision of the two links' fair share (line 5). The minimum value of λ among all such pairs of links corresponds to the leap (line 7), while the links themselves constitute a fold (line 8). The algorithm returns both the leap and the fold (line 12).

The concept of leap and fold is relevant in that it enables a methodology to efficiently travel along the solution space defined by the bottleneck structure, towards reaching a certain performance objective is achieved. Specifically, for some x, y∈ [symbol] ∪ [symbol] , if x is perturbed negatively so as to benefit another flow or link in the network, but only up to the leap of x, i.e., λ, the negative and positive changes may be balanced. On the other hand, if x is perturbed negatively by more than its λ, the positive impact of this perturbation on another flow or link would not exceed λ, potentially resulting in degradation of the overall network performance.

We introduce a method in Algorithm 3, MinimizeFCT( ), shown in FIG. 4, that can identify a set of perturbations needed in a network to minimize the completion time of a given flow fₛ (also referred to as flow completion time (FCT)). The algorithm starts (line 2) by identifying a maximal gradient ∇_{f*}(fₛ). This corresponds to a direction in the solution space that improves the performance of f maximally. Then, it travels along such gradient by an amount equal to its leap (lines 6 through 11). This is achieved by adding a logical link lₖ that acts as a traffic shaper reducing the rate of flow f* by the leap amount. This causes the intended perturbation, thus resulting in the increase of flow fₛ's rate by the amount leap×∇_{f*}(fₛ).

From Lemma 4, we know that the additional traffic shaper changes the structure of the gradient graph, at which point we need to iterate again the procedure (line 1) to recompute the new values of the gradients based on the new structure. This process is repeated iteratively until either no more positive gradients are found or the performance of fₛ has increased above a given rate target ρ (lines 3 and 4). In the next section, an example is presented demonstrating how embodiments of MinimizeFCT( ) may be used to optimize the performance of a time-bound constrained flow.

3 Applications to Data Networks

Because the existence of bottleneck structures are a fundamental property intrinsic to any congestion-controlled data network, its applications are numerous in a variety of network communication problems. In this section, our goal is to present some examples illustrating how the proposed Theory of Bottleneck Structures (TBS) introduced in the previous section can be used to resolve some of these problems. We show that in each of them, the framework is able to provide new insights into one or more operational aspects of a network. The examples presented in this section are not exhaustive, but only illustrative. To help organize the breadth of applications, we divide them in two main classes: traffic engineering and capacity planning. For each of these classes, we provide specific examples of problems that relate to applications commonly found in modern networks.

3.1 Traffic Engineering

3.1.1 Scheduling Time-Bound Constrained Flows

Suppose that our goal is to accelerate a flow fₛ∈F in a network [symbol] with the objective that such flow is completed before a certain time-bound requirement. A common application for the optimization of time-bound constrained flows can be found in research and education networks, where users need to globally share data obtained from their experiments, often involving terabytes or more of information—e.g., when scientists at the European Organization for Nuclear Research (CERN) need to share data with other scientific sites around the world using the LHCONE network. Another common use case can be found in large scale data centers, where massive data backups need to be transferred between sites to ensure redundancy. In this context, suppose the operators are only allowed to sacrifice the performance of a subset of flows [symbol] ′⊂ [symbol] {fₛ}, considered of lower priority than fₛ. What flows in [symbol] ′ present an optimal choice to accelerate fₛ? By what amount should the rate of such flows be reduced? And by what amount will flow fₛ be accelerated?

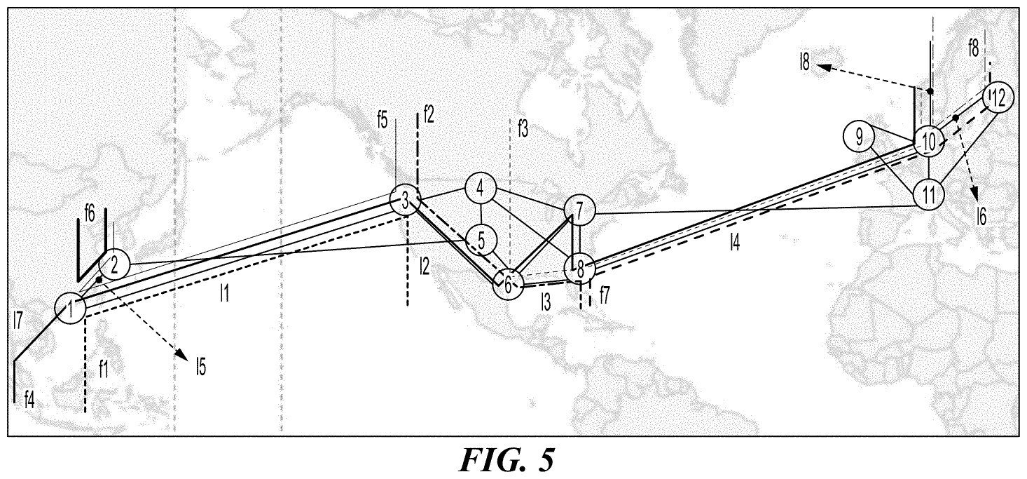

To illustrate that we can use TBS to resolve this class of problems, consider the network shown in FIG. 5. This topology generally corresponds to Google's B4 network. In this experiment, assume there are eight flows, F={f₁, f₂, . . . , f₈}, routed as shown in the figure. While real-life networks usually operate with a much higher number of flows, in our example we use a reduced number merely to simplify the descriptions of the bottleneck structures and the steps followed to resolve the given problem. This is without loss of generality and the same approach is applicable to large scale operational networks, as discussed below.

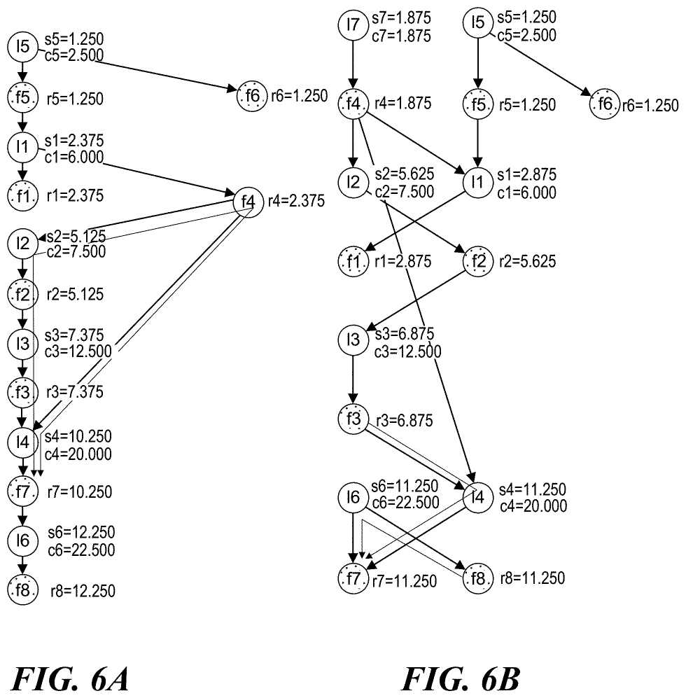

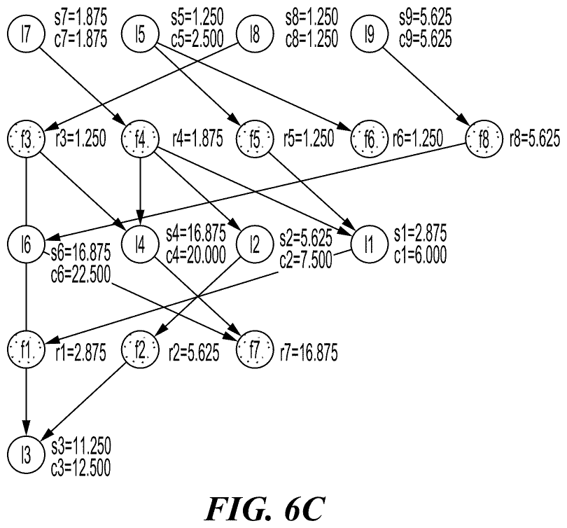

To identify an optimal strategy for accelerating an arbitrary flow in a network, we use an implementation of the MinimizeFCT( ) procedure (Algorithm 3, FIG. 4). Assume that our objective is to accelerate flow f₇ (i.e., fₛ=f₇) in FIG. 5—the transatlantic flow that connects data centers 8 and 12—towards meeting a certain flow completion time constraint. FIGS. 6A-6C provide a sequence of gradient graphs generated by Algorithm 3 every time line 6 is executed. The graphs include the values of the fair share sₗ next to each link vertex l and the rate r_{f} next to each flow vertex f.

FIG. 6A corresponds to the gradient graph of the initial network configuration shown in FIG. 5. At this iteration, the gradient calculations are: ∇_{f}_{₁}(f₇)=−2, ∇_{f}_{₂}(f₇)=−1, ∇_{f}_{₃}(f₇)=1, ∇_{f}_{₄}(f₇)=2, ∇_{f}_{₅}(f₇)=−1, ∇_{f}_{₆}(f₇)=1, ∇_{f}_{₈}(f₇)=0. Thus, in line 2 we have f₄=argmax_{f∈F}∇_{f}(fₛ)=2. From FIG. 6A, it can be observed that the reduction of flow f₄'s rate creates a perturbation that propagates through the bottleneck structure via two different paths: f₄→l₂→f₂→l₃→f₃→l₄→f₇ and f₄→l₄→f₇. Each of these paths has an equal contribution to the gradient of value 1, resulting in ∇_{f}_{₄}(f₇)=2. Note that since this value is larger than 1, it is understood to be a power gradient (Definition 8).

In line 7, we invoke LeapFold( [symbol] , [symbol] , f₄) (Algorithm 2, FIG. 3), which results in a fold (l₄, l₆) and a leap value of 0.5. In lines 8-11, we add a traffic shaper that reduces the rate of flow f₄ by 0.5 units (the value of the leap), bringing its value from 2.375 down to 1.875. This is implemented in Algorithm 3 (FIG. 4) by adding to the network a new link [symbol] ₊₁=l₇ (line 9) that is only traversed by flow f₄ (line 10) and with a capacity value of cₗ_{₇}=1.875 (line 11). From Definition 9, this corresponds to the maximum reduction of flow f₄'s rate that preserves the structure of the gradient graph. When the rate of f₄ is reduced by exactly 0.5, then the two links in the fold (l₄, l₆) collapse into the same level, as shown in FIG. 6B (sₗ_{₄}=sₗ_{₆}=11.25), changing the bottleneck structure of the network. At this point, flow f₇ becomes bottlenecked at both of these links (FIG. 6B), completing a first iteration of Algorithm 3 (FIG. 4).

The second iteration, thus, starts with the original network augmented with a traffic shaper l₇ that forces the rate of flow f₄ to be throttled at 1.875. Using its bottleneck structure (FIG. 6B), it can be seen that we can further accelerate flow f₇ by decreasing the rate of flows f₃ and f₈, since both have a direct path to flow f₇ that traverses its bottleneck links l₄ and l₆. To ensure a maximal increase on the performance of flow f₇, we need to equally reduce the rate of both flows (r_{f}_{₃} and r_{f}_{₈}) so that the fair shares of the two bottleneck links (sₗ_{₄} and sₗ_{₆}) increase at an equal pace. This can be achieved by adding two new traffic shapers l₈ and l₉ to throttle the rate of flows f₃ and f₈, respectively, down from their current rates of 6.875 and 11.25, i.e.: cₗ_{₈}=6.875−x and cₗ_{₉}=11.25−x. Since the gradient of any flow (generally the flow to be accelerated) can be computed with respect to the flow to be traffic shaped, how much each flow will be decelerated or accelerated can be determined. With this information, the maximum value of the factor x that will not decelerate any flow below the minimum completion time or another specified threshold can be determined.

In FIG. 6C, we show the resulting bottleneck structure when choosing a value of x=5.6250 (cₗ_{₈}=1.25 and cₗ_{₉}=5.625). Note that there is some flexibility in choosing the value of this parameter, depending on the amount of acceleration required on flow f₇. In this case we chose a value that ensures none of the flows that are traffic shaped receives a rate lower than any other flow. With this configuration, flow f₃'s rate is reduced to the lowest transmission rate, but such value is no lower than the rate of flows f₅ and f₆ (r_{f}_{₃}=r_{f}_{₅}=r_{f}_{₆}=1.25). Thus, the flow completion time of the slowest flow is preserved throughout the transformations performed in this example.

In summary, a strategy to maximally accelerate the performance of flow f₇ consists in traffic shaping the rates of flows f₃, f₄ and f₈ down to 1.25, 1.875 and 5.625, respectively. Such a configuration results in an increase to the rate of flow f₇ from 10.25 to 16.875, while ensuring no flow performs at a rate lower than the slowest flow in the initial network configuration.

3.1.2 Identification of High-Bandwidth Routes

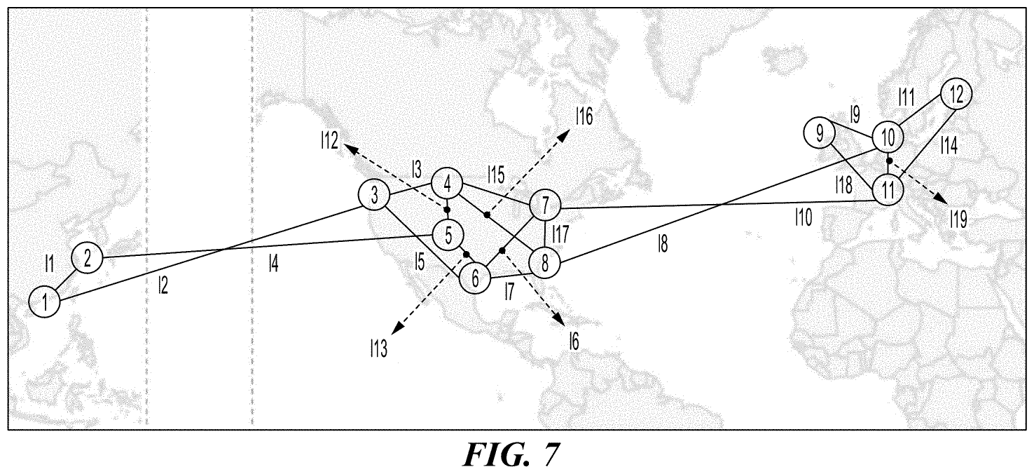

In this section, we show how TBS can also be used to identify high-bandwidth routes in a network. We will consider one more time the B4 network topology, but assume there are two flows (one for each direction) connecting every data center in the US with every data center in Europe, with all flows following a shortest path. Since there are six data centers in the US and four in Europe, this configuration has a total of 48 flows (| [symbol] |=6×4×2=48), as shown in FIG. 7. (See Tables 3A-1 and 3A-2 showing the exact path followed by each flow.) All links are assumed to have a capacity of 10 Gbps except for the transatlantic links, which are configured at 20 Gbps (cₗ=10, for all l∉{l₈, l₁₀}, cₗ_{₈}=cₗ_{₁₀}=20).

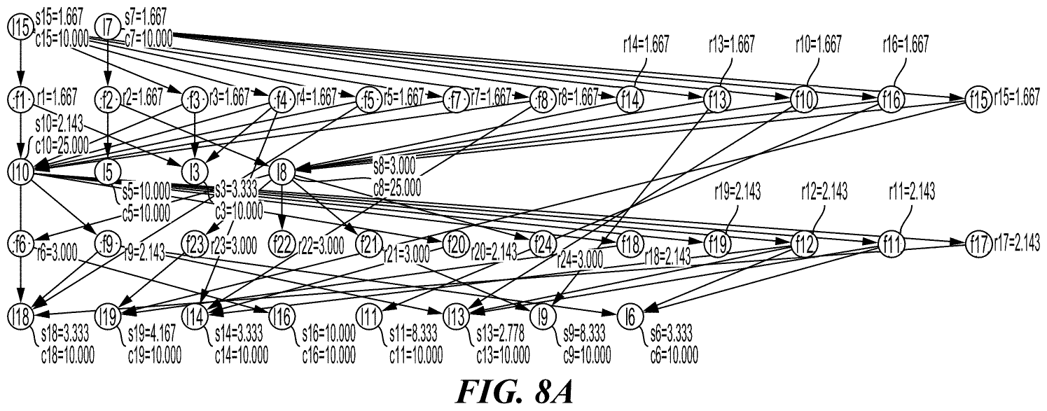

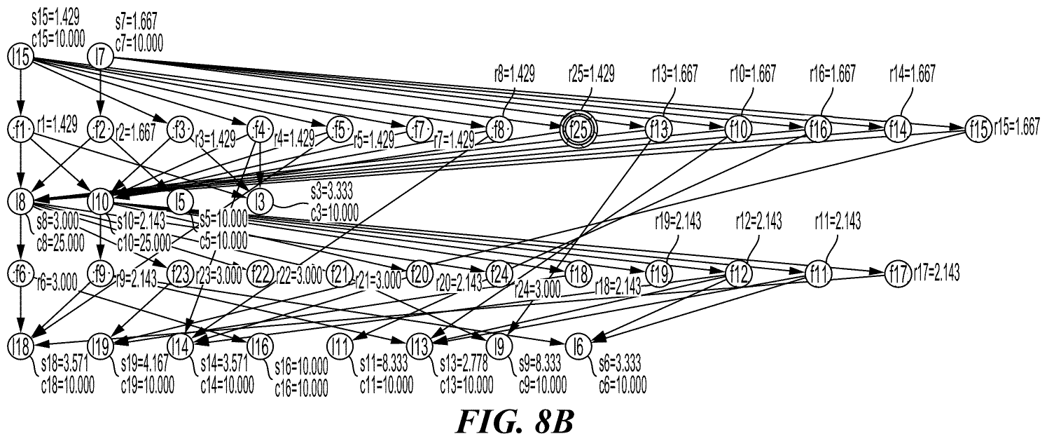

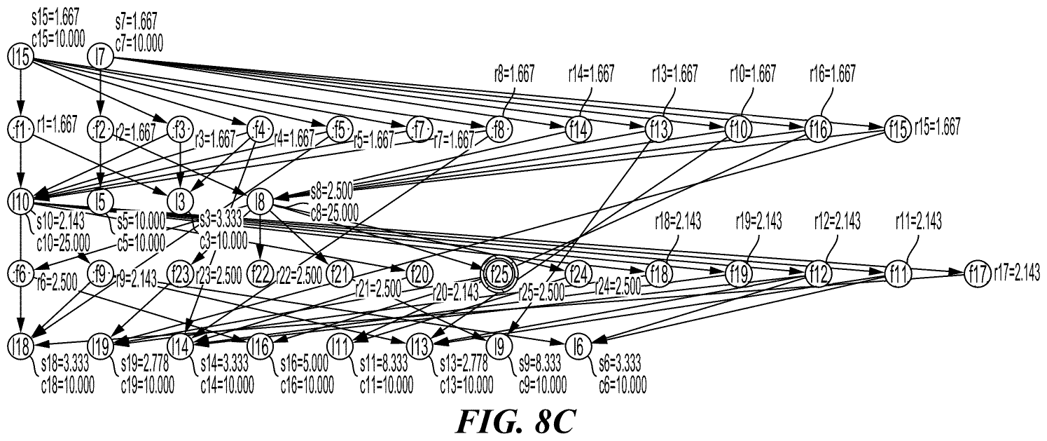

FIG. 8A shows the corresponding bottleneck structure obtained from running Algorithm 1A (FIG. 1A). This structure shows that flows are organized in two levels: the top-level includes flows {f₁, f₂, f₃, f₄, f₅, f₇, f₈, f₁₀, f₁₃, f₁₄, f₁₅, f₁₆} and the low-level includes flows {f₆, f₉, f₁₁, f₁₂, f₁₇, f₁₈, f₁₉, f₂₀, f₂₁, f₂₂, f₂₃, f₂₄}. Note that because each pair of data centers is connected via two flows (one for each direction), without loss of generality, in FIG. 8A we only include the first 24 flows (flows transferring data from US to Europe), since the results are symmetric for rest of the flows—i.e., flow fᵢ has the same theoretical transmission rate and is positioned at the same level in the bottleneck structure as flow fᵢ₊₂₄, for all 1≤i≤24.

Note also that all the top-level flows operate at a lower transmission rate (with all rates at 1.667) than the bottom-level flows (with rates between 2.143 and 3). This in general is a property of all bottleneck structures: flows operating at lower levels of the bottleneck structure have higher transmission rates than those operating at levels above. Under this configuration, suppose that we need to initiate a new flow f₂₅ to transfer a large data set from data center 4 to data center 11. Our objective in this exercise is to identify a high-throughput route to minimize the time required to transfer the data.

Because the bottleneck structure reveals the expected transmission rate of a flow based on the path it traverses, we can also use TBS to resolve this problem. In 8B we show the bottleneck structure obtained for the case that f₂₅ uses the shortest path l₁₅→l₁₀. Such configuration places the new flow at the upper bottleneck level—the lower-throughput level—in the bottleneck structure, obtaining a theoretical rate of r₂₅=1.429.

Note that the presence of this new flow slightly modifies the performance of some of the flows on the first level (flows {f₁, f₃, f₄, f₅, f₇, f₈} experience a rate reduction from 1.667 to 1.429), but it does not modify the performance of the flows operating at the bottom level. This is because, for the given configuration, the new flow only creates a shift in the distribution of bandwidth on the top level, but the total amount of bandwidth used in this level stays constant. (In Fig. ??, the sum of all the flow rates on the top bottleneck level is 1.667×12=20, and in Fig. ?? this value is the same: 1.429×7+1.667×6=20.) As a result, the ripple effects produced from adding flow f₂₅ into the network cancel each other out without propagating to the bottom level.

Assume now that, instead, we place the newly added flow on the non-shortest path l₁₆→l₈→l₁₉. The resulting bottleneck structure is shown in FIG. 8C. This configuration places flow f₂₅ at the bottom level—the higher-throughput level—in the bottleneck structure, thus resulting in a rate value r₂₅=2.5, an increase of 74.95% with respect to the shortest path solution. Another positive outcome of this solution is that none of the flows operating at the upper level (the flows that receive less bandwidth) see their rate reduced. This is a direct consequence of Lemma 1, since a perturbation on lower levels have no ripple effects on upper levels.

In conclusion, for the given example, the non-shortest path solution achieves both a higher throughput for the newly placed flow and better fairness in the sense that such allocation—unlike the shortest path configuration—does not deteriorate the performance of the most poorly treated flows.

3.2 Capacity Planning

3.2.1 Design of Fat-Tree Networks in Data Centers

In this experiment, we illustrate how TBS can be used to optimize the design of fat-tree network topologies. Fat-trees are generally understood to be universally efficient networks in that, for a given network size s, they can emulate any other network that can be laid out in that size s with a slowdown at most logarithmic in s. This property is one of the underlying mathematical principles that make fat-trees (also known as folded-clos or spine-and-leaf networks) highly competitive and one of the most widely used topologies in large-scale data centers and high-performance computing (HPC) networks.

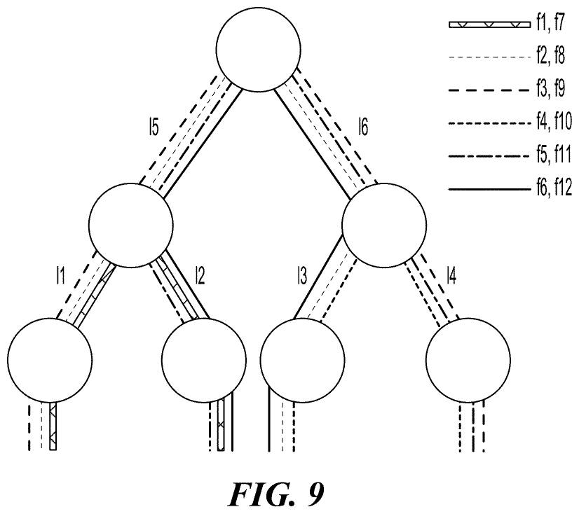

Consider the network topology in FIG. 9, which corresponds to a binary fat-tree with three levels and six links ( [symbol] ={l₁, l₂, . . . , l₆}). Assume also that there are two flows (one for each direction) connecting every pair of leaves in the fat-tree network, providing bidirectional full-mesh connectivity among the leaves. Since there are four leaves, that results in a total of 4×3=12 flows. All of the flows are routed following the shortest path, as shown in Table 1 below. For the sake of convention, we adopt the terminology from data center architectures and use the names spine and leaf links to refer to the upper and lower links of the fat-tree network, respectively.

TABLE 1
Path followed by each flow in the fat-tree networks experiments

| Flow | Experiment 1, 2, 3: Links traversed |
|---|---|
| f₁ | {l₁, l₂} |
| f₂ | {l₁, l₅, l₆, l₃} |
| f₃ | {l₁, l₅, l₆, l₄} |
| f₄ | {l₂, l₁} |
| f₅ | {l₂, l₅, l₆, l₃} |
| f₆ | {l₂, l₅, l₆, l₄} |
| f₈ | {l₃, l₆, l₅, l₂} |
| f₉ | {l₃, l₄} |
| f₁₀ | {l₄, l₆, l₅, l₁} |
| f₁₁ | {l₄, l₆, l₅, l₂} |
| f₁₂ | {l₄, l₃} |

ConsidWe fix the capacity of the leaf links to a value λ (i.e., cₗ_{₁}=cₗ_{₂}=cₗ_{₃}=cₗ_{₄}=λ) and the capacity of the spine links to λ×τ (i.e., cₗ_{₅}=cₗ_{₆}=λ×τ), where τ is used as a design parameter enabling a variety of network designs. For instance, in our binary fat-tree example, the case τ=2λ corresponds to a full fat-tree network, because the total aggregate bandwidth at each level of the tree is constant, cₗ_{₁}+cₗ_{₂}+cₗ_{₃}+cₗ_{₄}=cₗ_{₅}+cₗ_{₆}=4λ. Similarly, the case τ=1 corresponds to a thin-tree network, since it results with all the links having the same capacity, cₗ_{ᵢ}=λ, for all 1≤i≤6. The conventional technique of optimizing the performance-cost trade-off of a fat-tree network by adjusting the capacity of the spine links is sometimes referred as bandwidth tapering.

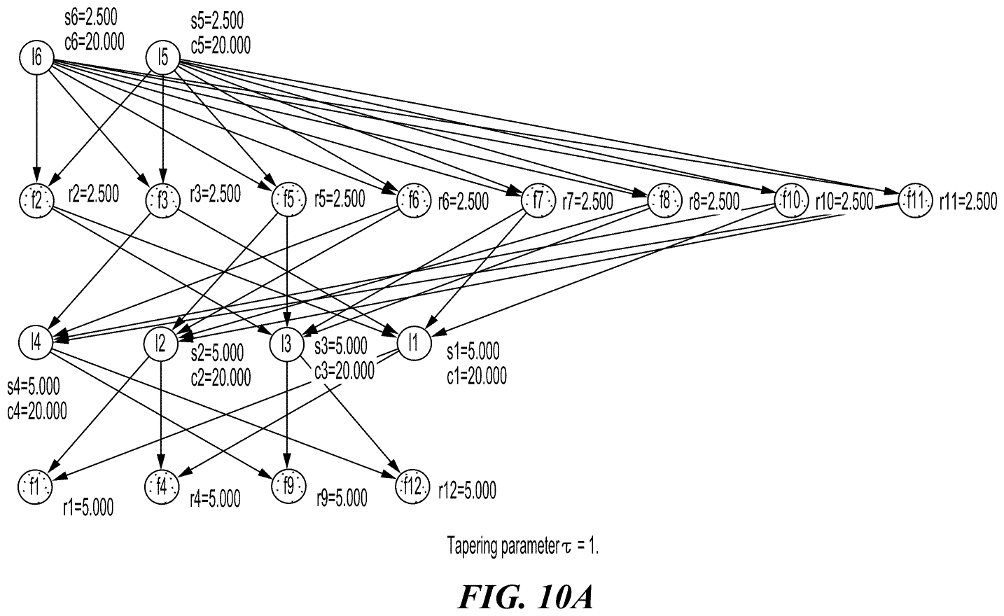

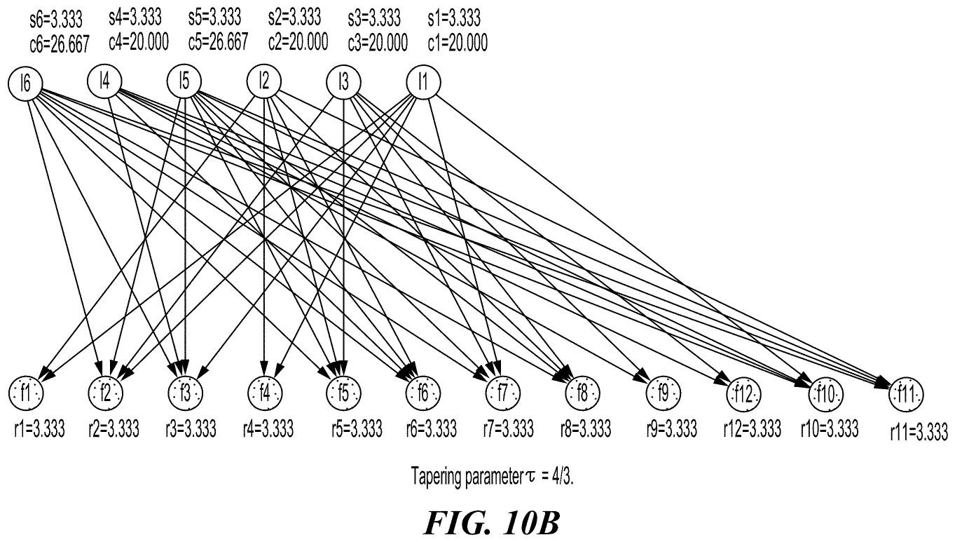

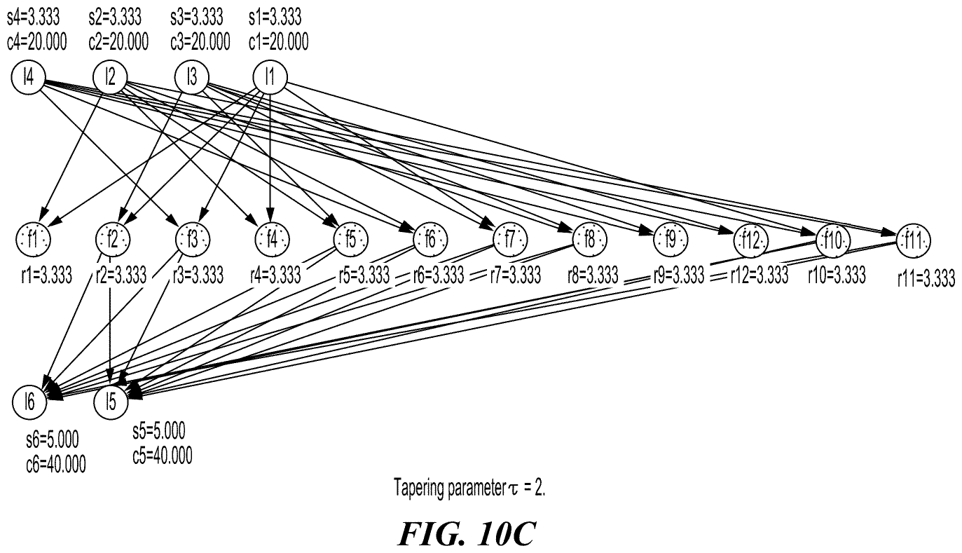

The focus of our experiment is to use the bottleneck structure analysis to identify optimized choices for the tapering parameter τ. In FIGS. 10A-10C, we present sequences of bottleneck structures (obtained from running Algorithm 1A (FIG. 1A)) corresponding to our fat-tree network with three different values of the tapering parameter τ and fixing λ=20. Note that the fixing of λ to this value is without loss of generality, as the following analysis applies to any arbitrary value λ>0.

The first bottleneck structure (FIG. 10A) corresponds to the case τ=1 (i.e., all links have the same capacity, cₗ_{ᵢ}=20, for all 1≤i≤6). This solution leads to a bottleneck structure with flows confined in one of two possible levels: a top level, where flows perform at a lower rate, r_{f}_{₂}=r_{f}_{₃}=r_{f}_{₅}=r_{f}_{₆}=r_{f}_{₇}=r_{f}_{₈}=r_{f}_{₁₀}=r_{f}_{₁₁}=2.5; and a bottom level, where flows perform at twice the rate of the top-level flows, r_{f}_{₁}=r_{f}_{₄}=r_{f}_{₉}=r_{f}_{₁₂}=5. This configuration is thus unfair to those flows operating at the top bottleneck. Furthermore, if the data sets to be transferred over the fat-tree are known to be symmetric across all nodes, this configuration is not optimal. This is because in such workloads, a task is not completed until all flows have ended. Thus, the best configuration in this case is one that minimizes the flow completion time of the slowest flow. Let us consider how we can use TBS to identify a value of r that achieves this objective.

By looking at the bottleneck structure in FIG. 10B, we know that the slowest flows are confined in the top bottleneck level. In order to increase the rates of these flows, we need to increase the tapering parameter r that controls the capacity of the spine links l₅ and l₆. Such action transforms the bottleneck structure by bringing the two levels closer to each other, until they fold. We can obtain the collision point by computing the link gradients and their leap and fold as follows. The link gradient of any of the spine links with respect to any of the top-level flows is ∇ₗ(f)=0.125, for all l∈{l₅, l₆} and f∈{f₂, f₃, f₅, f₆, f₇, f₈, f₁₀, f₁₁}.

On the other hand, the link gradient of any of the spine links with respect to any of the low-level flows is ∇ₗ(f)=−0.25, for all l∈{l₅, l₆} and f∈{f₁, f₄, f₉, f₁₂}. That is, an increase by one unit on the capacity of the spine links increases the rate of the top-level flows by 0.125 and decreases the rate of the low-level flows by 0.25. Since the rates of the top and low-level flows are 2.5 and 5, respectively, this means that the two levels will fold at a point where the tapering parameter satisfies the equation 2.5+0.125·τ·λ=5−0.25·τ·λ, resulting in

$$τ = \frac{4}{3}$$

and, thus, cₗ_{₅}=cₗ_{₆}=26.667.

Note that this value corresponds exactly to the leap of the spine links gradient, and thus can also be programmatically obtained using Algorithm 2 (FIG. 3). The resulting bottleneck structure for this configuration is shown in FIG. 10B, confirming the folding of the two levels. This fat-tree configuration is optimal in that the flow completion time of the slowest flow is minimal. Because the bottleneck structure is folded into a single level, this configuration also ensures that all flows perform at the same rate, r_{f}_{ᵢ}=3.333, for all 1≤i≤6.

What is the effect of increasing the tapering parameter above

$$\frac{4}{3} ?$$

This result is shown in FIG. 10C for the value of τ=2, i.e., cₗ_{₅}=cₗ_{₆}=40. In this case, the two spine links are no longer bottlenecks to any of the flows (since these links are leaves in the bottleneck structure), but all flows continue to perform at the same rate, r_{f}_{ᵢ}=3.333, for all 1≤i≤6. Thus, increasing the capacity of the upper-level links does not yield any benefit, but increases the cost of the network. This result indicates that the fat-tree network shown in FIG. 9 should not be designed with an allocation of capacity on the spine links higher than

$$τ = \frac{4}{3}$$

times the capacity of the leaf links.

In summary, for the fat-tree network shown in FIG. 9 we have:

A tapering parameter

$$τ \geq \frac{4}{3}$$

should never be used, as that is as efficient as a design with

$$τ = \frac{4}{3} ,$$

but more costly.

A tapering parameter

$$τ = \frac{4}{3}$$

is optimal in that it minimizes the flow completion time of the slowest flow. This should be the preferred design in symmetric workloads that transfer about the same amount of data between any two nodes.

A tapering parameter

$$τ < \frac{4}{3}$$

can be used if workloads are asymmetric, identifying the right value of τ that produces the right amount of bandwidth at each level of the bottleneck structure according to the workload.

Note that this result might be counter-intuitive if we take some of the established conventional best practices. For instance, while a full fat-tree (τ=2, in our example) is generally considered to be efficient, the analysis of its bottleneck structure, as presented above, demonstrates that such design is inefficient when flows are regulated by a congestion-control protocol, as is the case of many data centers and HPC networks. See section 4.3 where we experimentally demonstrate this result using TCP congestion control algorithms. It should be understood that the value of τ, in general, will depend on the network topology and would not always be

$$\frac{4}{3}$$

but that given a network topology, an optimized value of τ can be determined using the gradient graph and the leap-fold computation, as described above.

4 Bottleneck Structure to Compute Incremental Directions in Multipath Networks

Data may be sent between pairs of nodes in a network The pairs may communicate via multiple paths. For example, wide area networks connecting data centers across a global network may use multiple paths. A cheapest path may be desirable to improve the overall system. How much bandwidth to allocate to each path should also be determined. The problem of finding multipath max-min bandwidth allocations is known to be computationally hard to resolve. Existing solutions implement water-filling heuristics that yield suboptimal allocations. Because these solutions require performing a water-filling technique from scratch, attempting to find incremental directions in a search space that lead to higher performance solutions by making small network modifications (e.g., changing the path or the rate of a flow) on the current bandwidth allocation is very expensive. Bottleneck structures can facilitate these types of calculations orders of magnitude faster than existing water-filling techniques because the bottleneck structures can obtain the resulting bandwidth allocation by recomputing only those flows that are affected by the network modification. This enables a class of processes that can efficiently search new bandwidth allocations within the neighborhood of the current solution and identify an incremental direction; that is, a path within the feasible set of bandwidth allocations that has higher performance than the current solution.

Aspects of the present disclosure introduce a procedure to compute an initial multipath bottleneck structure. In some aspects, a bottleneck structure is used to identify a change in a rate of a flow that yields an improved bandwidth allocation. In other aspects, the bottleneck structure is used to identify a change in a path of a flow that yields an improved bandwidth allocation.

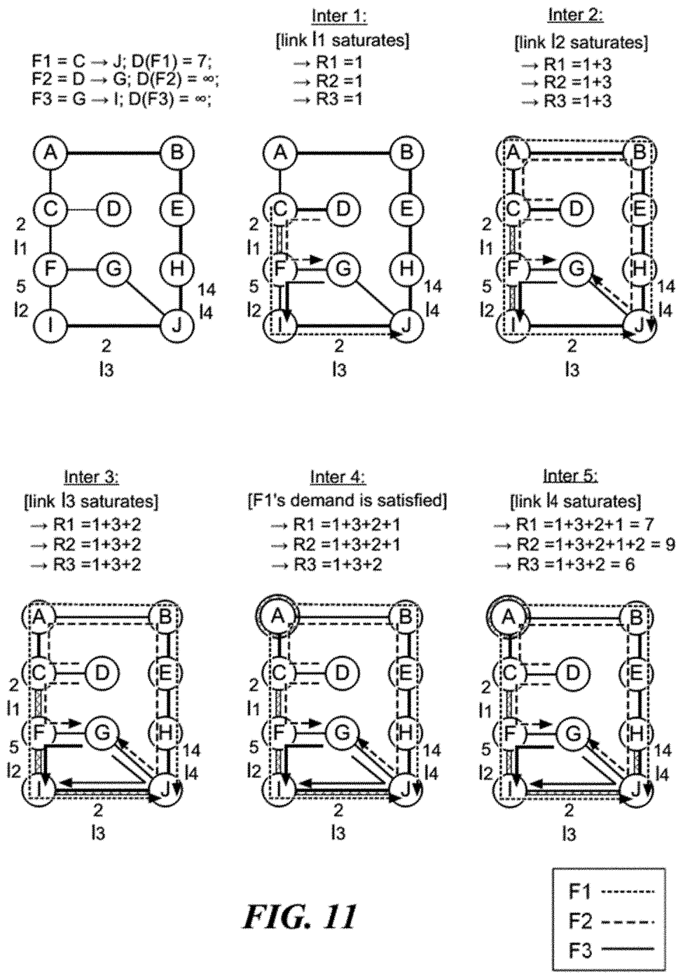

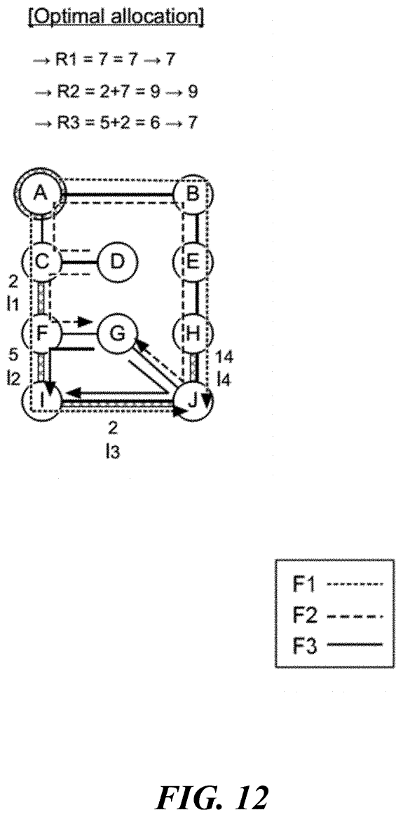

A solution to the multipath max-min problem may be generated with an arbitrary solution, such as that found by a greedy algorithm. An example of a solution is the bandwidth allocation obtained by running the water-filling greedy algorithm described in Section 4.3, “TE Optimization Algorithm” of the paper “B4: experience with a globally-deployed software defined wan” by Sushant Jain et al. FIGS. 11 and 12 illustrate the bandwidth allocation obtained with such a greedy algorithm, in accordance with various aspects of the present disclosure. In FIG. 11, the notation F_i stands for flow group i, D(F_i) stands for the demand of flow group F_i, and R(R_i) represents the resulting bandwidth allocation for flow group F_i. Without loss of generality, we assume that the cost of a path is equal to the number of links (hops) it traverses.

In FIG. 11, three flows F1, F2, F3 are shown. The first flow F1 is from vertex C to vertex J and has a bandwidth demand of 7 units. Potential paths for the first flow F1 are indicated with a dotted line. The second flow F2 is from vertex D to vertex G and has an infinite demand. Potential paths for the second flow F2 are indicated with a dashed line. The third flow F3 is from vertex G to vertex I and also has an infinite demand. Potential paths for the third flow F3 are indicated with a solid line. After multiple iterations, the resulting bandwidth allocation [R1, R2, R3]=[7, 9, 6] is found, meaning flow F1 is allocated seven bandwidth units, flow F2 is allocated nine bandwidth units, and flow F3 is allocated six bandwidth units. The bandwidth allocation is suboptimal because there exists another solution that provides both better total throughput and better fairness. Fairness is understood in the leximin order sense. Lexmin is defined as for a vector x=(x1, . . . , xn), where x is leximin-larger than a vector y=(y1, . . . , yn) if one of the following holds: the smallest element of x is larger than the smallest element of y; the smallest elements of both vectors are equal, and the second-smallest element of x is larger than the second-smallest element of y; . . . the k smallest elements of both vectors are equal, and the (k+1)-smallest element of x is larger than the (k+1)-smallest element of y. In the graph of FIG. 11, a better allocation is [R1, R2, R3]=[7, 9, 7] corresponding to the network configuration shown in FIG. 12.

Finding an improved or even optimal solution is known to be computationally hard and, thus far, infeasible for production networks. Aspects of the present disclosure employ a computational graph, referred to as a bottleneck structure, which allows the computation of greedy algorithm produced bandwidth allocations resulting from small variations on a given network configuration very efficiently by avoiding recomputing the bandwidth allocations from scratch for the whole network. With this technique, such computations can be performed orders of magnitude faster than with existing techniques. Further, this technique based on bottleneck structures provides easy to identify strategies to find incremental directions that otherwise would be difficult (or computationally infeasible) to identify with the current water-filling algorithms.

Notation wise, a flow group is the set of flows that connect pairs of nodes in the network. Each flow connects a pair of nodes in the network following a single path and is part of the flow group between that pair of nodes.

The multipath bottleneck structure may start with a bandwidth allocation computed by a greedy algorithm, such as the water filling technique described with respect to FIG. 11. The bottleneck structure may be computed as follows. Flows, bottleneck links, and flow group demands are vertices labeled f_x, l_y, and d_z, respectively. A bottlenecked link is a fully utilized link, in other words, a saturated link that is constrained. A flow group demand is a maximum rate for a flow. If a flow traverses a link, an edge extends between the link vertex and the flow vertex. If a flow group has a non-infinite demand, an edge extends between the demand vertex and all flow vertices in the flow group. In some aspects of the present disclosure, every flow should traverse at least one link that is fully utilized.

An incremental direction may be determined using weight optimization. With this technique, a bottleneck structure is built, and a flow group F is selected that is allocated low bandwidth in relation to the rest of the flow groups. For example, a flow group may be selected with the lowest value, or the second lowest value, or the third lowest value, etc. For a flow f in the flow group F, the allocation is increased by a small (e.g., infinitesimal) amount (delta). The bottleneck structure is then used to compute updated network allocations. If the resulting allocations as computed by the bottleneck structure are leximin-larger, the updated allocation is accepted. The weight optimization technique increases fairness by improving throughput of the flows that are allocated less bandwidth.

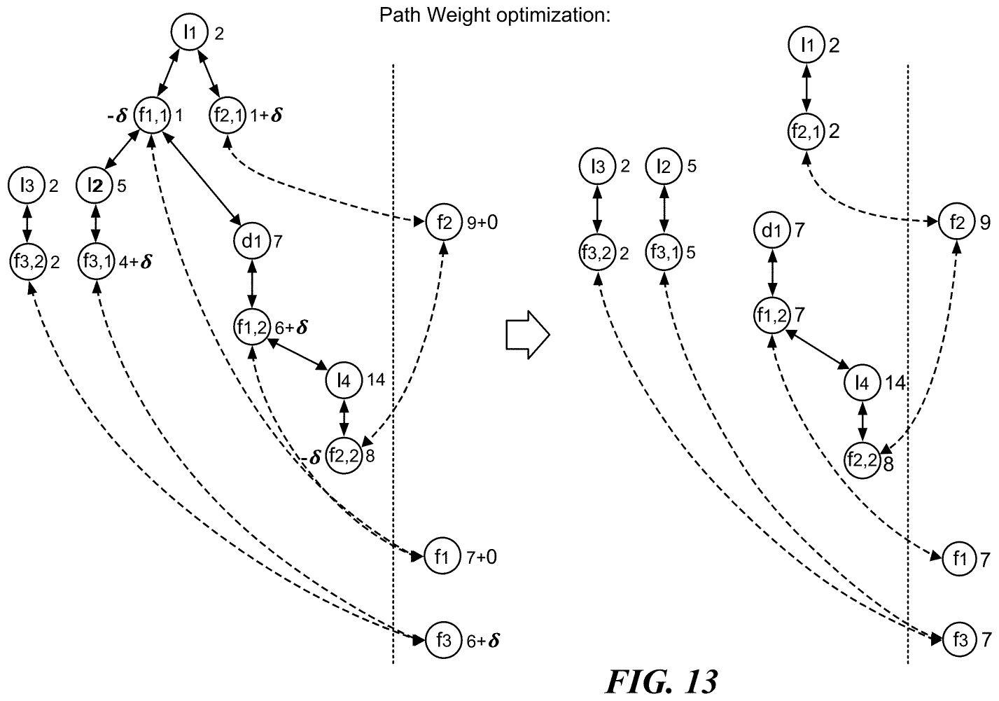

FIG. 13 is a diagram illustrating two bottleneck structures, in accordance with various aspects of the present disclosure. In the example of FIG. 13, we select flow group F=F_3 as a flow group with a bandwidth allocation we attempt to increase. Referring to the left half of FIG. 13, the flow group F_3 is the lowest throughput flow group in comparison to the other flow groups. That is, the flow F_3 is allocated six bandwidth units, whereas the first and second flow groups F_1 and F_2 are allocated seven and nine units, respectively. The flow group F_3 has two subflows in the example of FIG. 13: f_3,1, and f_3,2, with four units and two units, respectively, of bandwidth. The subflow f_3,1 traverses link l_2, which has five units of capacity. Subflow f_3,2 traverses link l_3 which has two units of capacity.

Flow group F_1 has two subflows, f_1,1 and f_1,2, each with a demand of seven. Subflow f_1,1 has one unit and traverses link l_2, and also link l_1, which has two units of capacity. Flow group F_2 has an infinite demand, is allocated nine units of bandwidth, and includes subflows f_2,1 and f_2,2. Subflow f_2,1 has one allocated bandwidth unit from link l_1. Subflow f_2,2 receives eight units, from link l_4, which has 14 units of capacity.

In the example of FIG. 13, flow f_3,1 increases by delta. The ripple effect is computed using the bottleneck structure. In the example of FIG. 13, the effect is that flows f_1,1 and f_2,2 decrease by one, and flows f_1,2 and f_2,1 increase by one unit each. Such a propagation leads to a new bandwidth allocation [7+0, 9+0, 6+delta], which is larger in the leximin sense than the previous allocation [7, 9, 6]. We call this an incremental direction. The new allocation is accepted, as seen in the right half of FIG. 13.

Aspects of the present disclosure calculate a maximal progress on the incremental direction. The previous procedure provides a direction (an infinitesimal change) on which a new allocation may be found that yields a better solution. The right half of FIG. 13 shows how to progress in such a direction to achieve a maximal improvement. The general idea here is to increase the value of delta until it becomes unfeasible to further progress on the current direction, at which point the procedure for finding an incremental direction using weight optimization repeats to find a new incremental direction. Without loss of generality, the following enumerates a few situations in which further progress on a given direction becomes unfeasible, which allows us to compute the maximum value of delta for a given incremental direction. The progress becomes unfeasible when the throughput of a flow is reduced to zero. This effectively means that such a flow vertex disappears from the bottleneck structure graph. The progress becomes unfeasible when the throughput of a flow increases to a point where a previously unsaturated link becomes saturated (e.g., fully utilized), so the bandwidth allocated to such a flow cannot be further increased. The progress also becomes unfeasible when the throughput of a flow increases to a point where its corresponding flow group throughput becomes equal to its demand.

In other aspects of the present disclosure, an incremental direction is found with a path optimization technique, by adjusting a route. In these aspects, a bottleneck structure is computed, as previously described. A flow group F is selected. In some aspects, the selected flow group is allocated a low bandwidth in relation to the rest of the flow groups. For example, the flow group may be selected with the lowest value, the second lowest value, the third lowest value, etc. In other aspects, a flow group with a highest allocation is selected. After selecting a flow group, the process removes from 0 to |F| flows from the flow group F and uses the bottleneck structure to compute the ripple effects, where |F| represents the cardinality of flow group F. For example, if the flow group has two flows, zero, one, or two flows are removed from the flow group. The process then applies the Dijkstra algorithm using the inverse of the fair share as the distance metric (as described in “A Quantitative Theory of Bottleneck Structures for Data Networks,” Reservoir Labs Technical Report, 2021) to compute a new path for flow group F. The resulting allocation as computed by the bottleneck structure is verified as to whether it is an incremental direction (that is, a leximin-larger allocation than the previous allocation). If so, then this procedure exits, and the new allocation is selected.

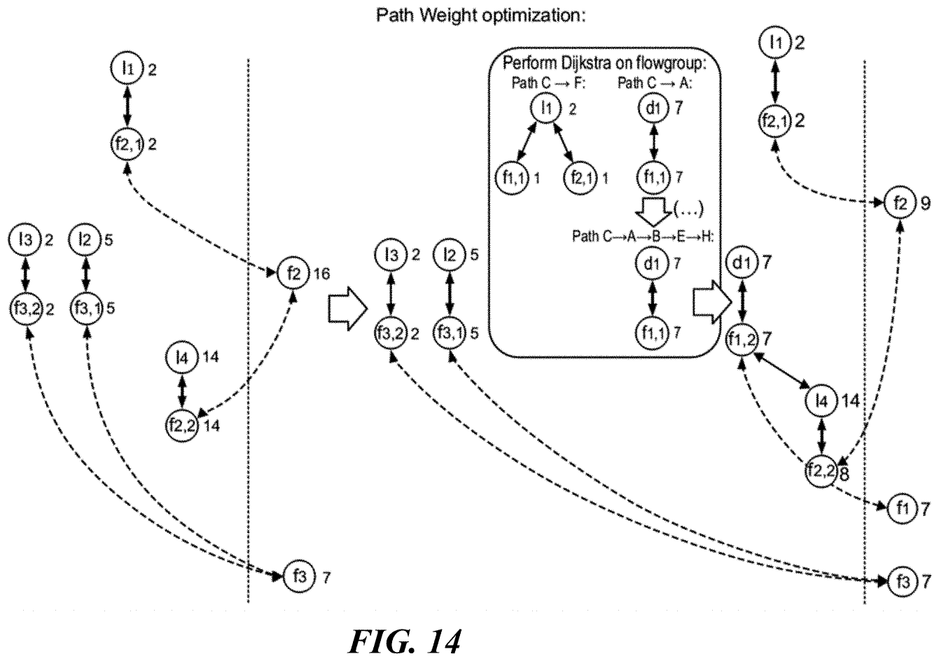

An example of finding the incremental direction using path optimization is shown in FIG. 14. FIG. 14 is a diagram illustrating a bottleneck structure, in accordance with various aspects of the present disclosure. In the example of FIG. 14, flow group F=F_1 is selected as a flow with a bandwidth allocation we attempt to increase. The flow group F_1 is a low throughput flow group in comparison to the other flow groups. Flow group F_1 is removed, in other words, the flows f_1,1 and f_1,2 are removed. A new bottleneck structure is computed resulting in the left-most bottleneck structure shown in FIG. 14. The Dijkstra process is applied using the inverse of the fair share as the distance metric and the ripple effect is computed using the bottleneck structure, resulting in the right-most bottleneck structure shown in FIG. 14. As seen in the right-most bottleneck structure shown in FIG. 14, the Dijkstra process analyzes potential paths from node C. Referring back to FIG. 11, it can be seen that the first step on the path from node C to node J can be either from node C to node F or from node C to node A. The path from node C to node A permits an allocation of seven units versus an allocation of two units for the path from node C to node F. Thus, the path from node C to node A is selected as the initial link. The eventual path from node C to node A to node B to node E to node H is ultimately selected, and the bottleneck structure is updated, as seen in the right-most side of FIG. 14. Such a propagation leads to a new bandwidth allocation [7, 9, 7], which is larger in the leximin sense than the previous allocation [7, 9, 6]. The procedure returns this new allocation (which constitutes an incremental direction).

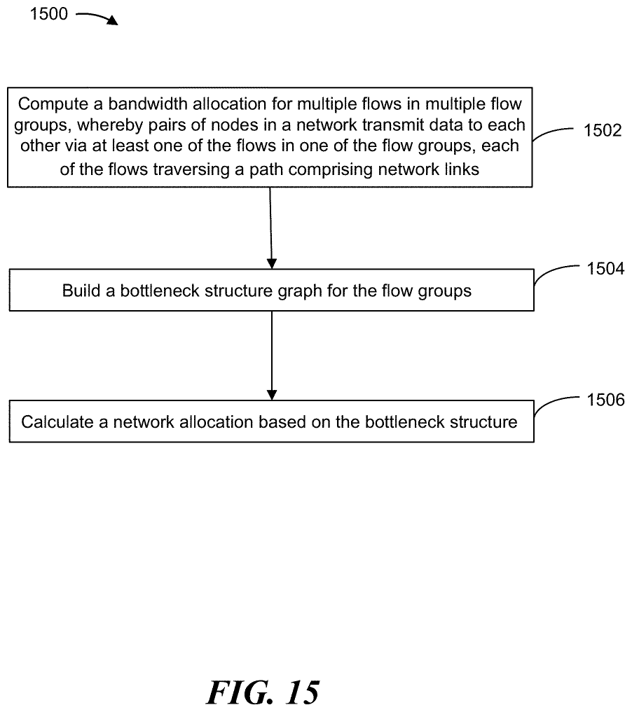

FIG. 15 is a flow diagram illustrating an example processor-implemented method 1500, in accordance with various aspects of the present disclosure. The example processor-implemented method 1500 is an example of using bottleneck structures to compute incremental directions in multipath networks. As shown in FIG. 15, in some aspects, the process 1500 may include computing a bandwidth allocation for a number of flows in a number of flow groups. Pairs of nodes in a network transmit data to each other via at least one of the number of flows in one of the number of flow groups. Each of the number of flows traverses a path comprising a number of network links (block 1502). In some aspects, the process 1500 may include building a bottleneck structure graph for the number of flow groups (block 1504). In some aspects, the process 1500 may include calculating a network allocation based on the bottleneck structure (block 1506).

### Example Aspects

Aspect 1: A processor-implemented method, comprising: computing a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links; building a bottleneck structure graph for the plurality of flow groups; and calculating a network allocation based on the bottleneck structure.

Aspect 2: The processor-implemented method of claim 1, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

Aspect 3: The processor-implemented method of Aspect 1 or 2, in which the calculating comprises: increasing an allocation for at least one flow in a selected flow group; determining an updated network allocation based on an updated bottleneck structure based on a change to the selected flow group; and selecting the updated network allocation if the updated allocation is leximin larger than the network allocation.

Aspect 4: The processor-implemented method of any of the preceding Aspects, in which the selected flow group has a lower bandwidth than other flow groups of the plurality of flow groups.

Aspect 5: The processor-implemented method of any of the preceding Aspects, further comprising increasing the allocation for each flow until at least one of: a throughput of any flow reduces to zero, the throughput of any flow increases to match a link capacity, or the throughput of the selected flow group matches a demand of the selected flow group.

Aspect 6: The processor-implemented method of any of the preceding Aspects, in which the calculating comprises: adjusting a path of one of the flows of the plurality of flow groups; determining an updated network allocation based on an updated bottleneck structure after adjusting the path; and selecting the updated network allocation if the updated allocation is leximin larger than the network allocation.

Aspect 7: The processor-implemented method of any of the preceding Aspects, in which adjusting the path comprises deleting the path and generating a new path to an existing flow group.

Aspect 8: The processor implemented method of any of the preceding Aspects, in which adjusting the path comprises adding a new path to an existing flow group.

Aspect 9: An apparatus comprising: a memory; and at least one processor coupled to the memory, the at least one processor configured: to compute a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links; to build a bottleneck structure graph for the plurality of flow groups; and to calculate a network allocation based on the bottleneck structure.

Aspect 10: The apparatus of Aspect 9, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

Aspect 11: The apparatus of Aspect 9 or 10, in which the at least one processor is further configured: to increase an allocation for at least one flow in a selected flow group; to determine an updated network allocation based on an updated bottleneck structure based on a change to the selected flow group; and to select the updated network allocation if the updated allocation is leximin larger than the network allocation.

Aspect 12: The apparatus of any of the Aspects 9-11, in which the selected flow group has a lower bandwidth than other flow groups of the plurality of flow groups.

Aspect 13: The apparatus of any of the Aspects 9-12, in which the at least one processor is further configured to increase the allocation for each flow until at least one of: a throughput of any flow reduces to zero, the throughput of any flow increases to match a link capacity, or the throughput of the selected flow group matches a demand of the selected flow group.

Aspect 14: The apparatus of any of the Aspects 9-13, in which the at least one processor is further configured: to adjust a path of one of the flows of the plurality of flow groups; to determine an updated network allocation based on an updated bottleneck structure after adjusting the path; and to select the updated network allocation if the updated allocation is leximin larger than the network allocation.

Aspect 15: The apparatus of any of the Aspects 9-14, in which the at least one processor is further configured to delete the path and generating a new path to an existing flow group.

Aspect 16: The apparatus of any of the Aspects 9-15, in which the at least one processor is further configured to add a new path to an existing flow group.

Aspect 17: An apparatus comprising: means for computing a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links; means for building a bottleneck structure graph for the plurality of flow groups; and means for calculating a network allocation based on the bottleneck structure.

Aspect 18: The apparatus of Aspect 17, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

Aspect 19: The apparatus of Aspect 17 or 18, in which the means for calculating comprises: means for increasing an allocation for at least one flow in a selected flow group; means for determining an updated network allocation based on an updated bottleneck structure based on a change to the selected flow group; and means for selecting the updated network allocation if the updated allocation is leximin larger than the network allocation.

Aspect 20: The apparatus of any of the Aspects 17-19, in which the selected flow group has a lower bandwidth than other flow groups of the plurality of flow groups.

Aspect 21: The apparatus of any of the Aspects 17-20, further comprising means for increasing the allocation for each flow until at least one of: a throughput of any flow reduces to zero, the throughput of any flow increases to match a link capacity, or the throughput of the selected flow group matches a demand of the selected flow group.

Aspect 22: The apparatus of Aspects 17-21, in which the means for calculating comprises: means for adjusting a path of one of the flows of the plurality of flow groups; means for determining an updated network allocation based on an updated bottleneck structure after adjusting the path; and means for selecting the updated network allocation if the updated allocation is leximin larger than the network allocation.

Aspect 23: The apparatus of any of the Aspects 17-22, in which the means for adjusting the path comprises deleting the path and generating a new path to an existing flow group.

Aspect 24: The apparatus of any of the Aspects 17-23, in which the means for adjusting the path comprises adding a new path to an existing flow group.

Aspect 25: A non-transitory computer-readable medium having program code recorded thereon, the program code executed by a processor and comprising: program code to compute a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links; program code to build a bottleneck structure graph for the plurality of flow groups; and program code to calculate a network allocation based on the bottleneck structure.

Aspect 26: The non-transitory computer-readable medium of Aspect 25, each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

Aspect 27: The non-transitory computer-readable medium of Aspect 25 or 26, in which the program code to calculate further comprises: program code to increase an allocation for at least one flow in a selected flow group; program code to determine an updated network allocation based on an updated bottleneck structure based on a change to the selected flow group; and program code to select the updated network allocation if the updated allocation is leximin larger than the network allocation.

Aspect 28: The non-transitory computer-readable medium of any of the Aspects 25-27, in which the selected flow group has a lower bandwidth than other flow groups of the plurality of flow groups.

Aspect 29: The non-transitory computer-readable medium of any of the Aspects 25-28, in which the program code further comprises program code to increase the allocation for each flow until at least one of: a throughput of any flow reduces to zero, the throughput of any flow increases to match a link capacity, or the throughput of the selected flow group matches a demand of the selected flow group.

Aspect 30: The non-transitory computer-readable medium of any of the Aspects 25-29, in which the program code to calculate further comprises: program code to adjust a path of one of the flows of the plurality of flow groups; program code to determine an updated network allocation based on an updated bottleneck structure after adjusting the path; and program code to select the updated network allocation if the updated allocation is leximin larger than the network allocation.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. Sets and subsets, in general, include one or more members.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed:

1. A processor-implemented method, comprising:
computing a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links;
building a bottleneck structure graph for the plurality of flow groups; and
calculating a network allocation based on the bottleneck structure.

2. The processor-implemented method of claim 1, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

3. The processor-implemented method of claim 1, in which the calculating comprises:
increasing an allocation for at least one flow in a selected flow group;
determining an updated network allocation based on an updated bottleneck structure based on a change to the selected flow group; and
selecting the updated network allocation if the updated allocation is leximin larger than the network allocation.

4. The processor-implemented method of claim 3, in which the selected flow group has a lower bandwidth than other flow groups of the plurality of flow groups.

5. The method of claim 3, further comprising increasing the allocation for each flow until at least one of: a throughput of any flow reduces to zero, the throughput of any flow increases to match a link capacity, or the throughput of the selected flow group matches a demand of the selected flow group.

6. The processor-implemented method of claim 1, in which the calculating comprises:
adjusting a path of one of the flows of the plurality of flow groups;
determining an updated network allocation based on an updated bottleneck structure after adjusting the path; and
selecting the updated network allocation if the updated allocation is leximin larger than the network allocation.

7. The processor-implemented method of claim 6, in which adjusting the path comprises deleting the path and generating a new path to an existing flow group.

8. The processor implemented method of claim 6, in which adjusting the path comprises adding a new path to an existing flow group.

9. An apparatus comprising:
a memory; and
at least one processor coupled to the memory, the at least one processor configured:
to compute a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links;
to build a bottleneck structure graph for the plurality of flow groups; and
to calculate a network allocation based on the bottleneck structure.

10. The apparatus of claim 9, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

11. The apparatus of claim 9, in which the at least one processor is further configured:
to increase an allocation for at least one flow in a selected flow group;
to determine an updated network allocation based on an updated bottleneck structure based on a change to the selected flow group; and
to select the updated network allocation if the updated allocation is leximin larger than the network allocation.

12. The apparatus of claim 11, in which the selected flow group has a lower bandwidth than other flow groups of the plurality of flow groups.

13. The apparatus of claim 11, in which the at least one processor is further configured to increase the allocation for each flow until at least one of: a throughput of any flow reduces to zero, the throughput of any flow increases to match a link capacity, or the throughput of the selected flow group matches a demand of the selected flow group.

14. The apparatus of claim 9, in which the at least one processor is further configured:
to adjust a path of one of the flows of the plurality of flow groups;
to determine an updated network allocation based on an updated bottleneck structure after adjusting the path; and
to select the updated network allocation if the updated allocation is leximin larger than the network allocation.

15. The apparatus of claim 14, in which the at least one processor is further configured to delete the path and generating a new path to an existing flow group.

16. The apparatus of claim 14, in which the at least one processor is further configured to add a new path to an existing flow group.

17. An apparatus comprising:
means for computing a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links;
means for building a bottleneck structure graph for the plurality of flow groups; and
means for calculating a network allocation based on the bottleneck structure.

18. The apparatus of claim 17, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

19. The apparatus of claim 17, in which the means for calculating comprises:
means for increasing an allocation for at least one flow in a selected flow group;
means for determining an updated network allocation based on an updated bottleneck structure based on a change to the selected flow group; and
means for selecting the updated network allocation if the updated allocation is leximin larger than the network allocation.

20. The apparatus of claim 19, in which the selected flow group has a lower bandwidth than other flow groups of the plurality of flow groups.

21. The apparatus of claim 19, further comprising means for increasing the allocation for each flow until at least one of: a throughput of any flow reduces to zero, the throughput of any flow increases to match a link capacity, or the throughput of the selected flow group matches a demand of the selected flow group.

22. The apparatus of claim 17, in which the means for calculating comprises:
means for adjusting a path of one of the flows of the plurality of flow groups;
means for determining an updated network allocation based on an updated bottleneck structure after adjusting the path; and
means for selecting the updated network allocation if the updated allocation is leximin larger than the network allocation.

23. The apparatus of claim 22, in which the means for adjusting the path comprises deleting the path and generating a new path to an existing flow group.

24. The apparatus of claim 22, in which the means for adjusting the path comprises adding a new path to an existing flow group.

25. A non-transitory computer-readable medium having program code recorded thereon, the program code executed by a processor and comprising:
program code to compute a bandwidth allocation for a plurality of flows in a plurality of flow groups, whereby pairs of nodes in a network transmit data to each other via at least one of the plurality of flows in one of the plurality of flow groups, each of the plurality of flows traversing a path comprising a plurality of network links;
program code to build a bottleneck structure graph for the plurality of flow groups; and
program code to calculate a network allocation based on the bottleneck structure.

26. The non-transitory computer-readable medium of claim 25, in which each flow comprises a first set of vertices, each link comprises a second set of vertices, and each flow group demand comprises a third set of vertices, and the network comprises a first set of edges, corresponding to a flow traversing a link, the first set of edges connecting a first flow vertex and a first link vertex, and a second set of edges, corresponding to a flow of a flow group with non-infinite demand, the second set of edges connecting a first demand vertex and a second flow vertex.

27. The non-transitory computer-readable medium of claim 25, in which the program code to calculate further comprises:
program code to increase an allocation for at least one flow in a selected flow group;
program code to determine an updated network allocation based on an updated bottleneck structure based on a change to the selected flow group; and
program code to select the updated network allocation if the updated allocation is leximin larger than the network allocation.

28. The non-transitory computer-readable medium of claim 27, in which the selected flow group has a lower bandwidth than other flow groups of the plurality of flow groups.

29. The non-transitory computer-readable medium of claim 27, in which the program code further comprises program code to increase the allocation for each flow until at least one of: a throughput of any flow reduces to zero, the throughput of any flow increases to match a link capacity, or the throughput of the selected flow group matches a demand of the selected flow group.

30. The non-transitory computer-readable medium of claim 25, in which the program code to calculate further comprises:
program code to adjust a path of one of the flows of the plurality of flow groups;
program code to determine an updated network allocation based on an updated bottleneck structure after adjusting the path; and
program code to select the updated network allocation if the updated allocation is leximin larger than the network allocation.
